(19) United States
(12) Patent Application Publication
(10) Pub. No.: US 2025/0338157 A1
(43) Pub. Date: Oct. 30, 2025

(54) THROUGHPUT-BASED BEAM REPORTING TECHNIQUES

(71) Applicant: QUALCOMM Incorporated, San Diego, CA (US)

(72) Inventors: Fang YUAN, Beijing (CN); Yan ZHOU, San Diego, CA (US); Ruhua HE, San Diego, CA (US); Jun ZHU, San Diego, CA (US); Mihir Vijay LAGHATE, San Diego, CA (US); Raghu Narayan CHALLA, San Diego, CA (US); Alexei Yurievitch GOROKHOV, San Diego, CA (US); Tao LUO, San Diego, CA (US)

(21) Appl. No.: 18/868,675

(22) PCT Filed: Jul. 29, 2022
(86) PCT No.: PCT/CN2022/109013

§ 371 Date: Nov. 22, 2024

(51) Int. Cl. H04W 24/10; H04B 7/06; H04L 5/00

(52) U.S. Cl. CPC H04W 24/10; H04B 7/0626; H04L 5/0051

(57) ABSTRACT

Methods, systems, and devices for wireless communications are described. Some wireless communications systems may support joint reporting of beam management information and channel state information (CSI). For example, a user equipment (UE) may transmit a message indicating a capability of the UE to support joint reporting of beam management information and CSI. Additionally, the UE may receive a control message indicating a reporting configuration for the joint reporting of the beam management information and the CSI, the reporting configuration indication aa CSI reference signal (CSI-RS) resource set including one or more CSI-RS resources that are associated with respective quasi co-location assumptions. In some cases, the reporting configuration may be based on the capability of the UE. Further, the UE may transmit one or more reports comprising the beam management information and the CSI based on the reporting configuration.

### CROSS REFERENCE

The present Application is a 371 national stage filing of International PCT Application No. PCT/CN2022/109013 by YUAN et al. entitled “THROUGHPUT-BASED BEAM REPORTING TECHNIQUES,” filed Jul. 29, 2022, which is assigned to the assignee hereof, and which is expressly incorporated by reference in its entirety herein.

### FIELD OF TECHNOLOGY

The following relates to wireless communications, including throughput-based beam reporting techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support throughput-based beam reporting techniques. Generally, the techniques described herein may enable a wireless device, such as a user equipment (UE), to transmit a joint report including beam management information and channel state information (CSI). For example, a UE may transmit, to a network entity, a capability message indicating a capability of the UE to support joint reporting of the beam management information and CSI. In some cases, the capability message may include an indication of a threshold quantity of CSI reference signal (CSI-RS) ports supported by the UE for measuring CSI-RS resources of a CSI-RS resource set. In some other cases, the capability message may include an indication of a range of quantities of CSI-RS ports supported by the UE for measuring the CSI-RS resources of the CSI-RS resource set. The UE may receive, from the network entity, a control message indicating a reporting configuration for the joint reporting of the beam management information and the CSI, where the reporting configuration indicates the CSI-RS resource set including the CSI resources to be measured by the UE. In some aspects, each of the CSI-RS resources of the CSI-RS resource set may be associated with different quasi co-location (QCL) assumptions. The reporting configuration may be based on the capability of the UE. In some cases, the UE may perform measurements of the CSI-RS resources of the CSI-RS resource set for acquiring beam management information, CSI, or both. The UE may transmit one or more reports including the beam management information and the CSI based on the reporting configuration.

A method for wireless communications at UE is described. The method may include transmitting a capability message indicating a capability of the UE to support joint reporting of beam management information and CSI, receiving a control message indicating a reporting configuration for the joint reporting of the beam management information and the CSI, the reporting configuration indicating a CSI-RS resource set including one or more CSI (CSI)-RS resources that are associated with respective QCL assumptions, where the reporting configuration is based on the capability of the UE, and transmitting one or more reports including the beam management information and the CSI based on the reporting configuration.

An apparatus for wireless communications at a UE is described. The apparatus may include a memory, a transceiver, and at least one processor of the UE, the at least one processor coupled with the memory and the transceiver. The at least one processor may be configured to transmit a capability message indicating a capability of the UE to support joint reporting of beam management information and CSI, receive a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and transmit one or more reports including the beam management information and the CSI based on the reporting configuration.

Another apparatus for wireless communications at a UE is described. The apparatus may include means for transmitting a capability message indicating a capability of the UE to support joint reporting of beam management information and CSI, means for receiving a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and means for transmitting one or more reports including the beam management information and the CSI based on the reporting configuration.

A non-transitory computer-readable medium storing code for wireless communications at a UE is described. The code may include instructions executable by a processor to transmit a capability message indicating a capability of the UE to support joint reporting of beam management information and CSI, receive a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and transmit one or more reports including the beam management information and the CSI based on the reporting configuration.

In some examples of the method, apparatuses, and non-transitory computer-readable medium described herein, transmitting the capability message may include operations, features, means, or instructions for transmitting the capability message including an indication of a threshold quantity of CSI-RS ports that may be supported by the UE for measuring CSI-RS resources of the CSI-RS resource set, where the reporting configuration may be based on the indication of the threshold quantity of CSI-RS ports.

In some examples of the method, apparatuses, and non-transitory computer-readable medium described herein, the threshold quantity of CSI-RS ports includes a quantity of CSI-RS ports that may be supported by the UE for a set of multiple reporting configurations for the joint reporting of the beam management information and the CSI, the threshold quantity of CSI-RS ports being indicated per bandwidth part (BWP), per component carrier (CC), for a set of multiple CCs, or any combination thereof.

In some examples of the method, apparatuses, and non-transitory computer-readable medium described herein, transmitting the capability message may include operations, features, means, or instructions for transmitting the capability message including an indication of a range of quantities of CSI-RS ports supported by the UE for measuring CSI-RS resources of the CSI-RS resource set, where the reporting configuration may be based on the indication of the range of quantities of CSI-RS ports.

In some examples of the method, apparatuses, and non-transitory computer-readable medium described herein, the range of quantities of CSI-RS ports includes a range of quantities of CSI-RS ports that may be supported by the UE for set of multiple reporting configurations for the joint reporting of the beam management information and the CSI, the range of quantities of CSI-RS ports being indicated per BWP, per CC, for a set of multiple CCs, or any combination thereof.

Some examples of the method, apparatuses, and non-transitory computer-readable medium described herein may further include operations, features, means, or instructions for performing measurements of respective CSI-RS resources of the CSI-RS resource set for acquiring the beam management information, where the respective CSI-RS resources may be each associated with a set of multiple antenna ports, the respective CSI-RS resources being configured without repetition and may be each associated with different antenna ports.

Some examples of the method, apparatuses, and non-transitory computer-readable medium described herein may further include operations, features, means, or instructions for performing measurements of respective CSI-RS resources of the CSI-RS resource set for acquiring the CSI, where the respective CSI-RS resources may be each associated with a set of multiple antenna ports, the respective CSI-RS resources being configured with repetition.

Some examples of the method, apparatuses, and non-transitory computer-readable medium described herein may further include operations, features, means, or instructions for performing measurements of respective CSI-RS resources of the CSI-RS resource set for acquiring the beam management information and the CSI, where the respective CSI-RS resources may be each associated with a set of multiple antenna ports.

Some examples of the method, apparatuses, and non-transitory computer-readable medium described herein may further include operations, features, means, or instructions for performing measurements of the one or more CSI-RS resources of the CSI-RS resource set for acquiring the beam management information and the CSI, where transmitting the one or more reports includes and transmitting, based on the measurements, a first report including the beam management information and a second report including the CSI.

Some examples of the method, apparatuses, and non-transitory computer-readable medium described herein may further include operations, features, means, or instructions for performing measurements of the one or more CSI-RS resources of the CSI-RS resource set for acquiring the beam management information and the CSI, where transmitting the one or more reports includes and transmitting a report including CSI for CSI-RSs that may be associated with one or more beams, the one or more beams each satisfying a throughput threshold based on the measurements.

Some examples of the method, apparatuses, and non-transitory computer-readable medium described herein may further include operations, features, means, or instructions for performing measurements of the one or more CSI-RS resources of the CSI-RS resource set for acquiring the beam management information and the CSI, where transmitting the one or more reports includes and transmitting a report including a first report quantity associated with the beam management information and a second report quantity associated with the CSI.

In some examples of the method, apparatuses, and non-transitory computer-readable medium described herein, the first report quantity includes a first CSI-RS resource identifier value and a reference signal received power value and the second report quantity includes a second CSI-RS resource identifier value, a rank indicator (RI) value, a precoding matrix indicator (PMI) value, a channel quality indicator value (CQI), or any combination thereof.

Some examples of the method, apparatuses, and non-transitory computer-readable medium described herein may further include operations, features, means, or instructions for performing measurements of the one or more CSI-RS resources of the CSI-RS resource set for acquiring the beam management information and the CSI, where transmitting the one or more reports includes and transmitting a report including a joint report quantity associated with the beam management information and the CSI.

In some examples of the method, apparatuses, and non-transitory computer-readable medium described herein, the joint report quantity includes a CSI-RS resource identifier value, a reference signal received power value, a RI value, a PMI value, a CQI value, or any combination thereof.

Some examples of the method, apparatuses, and non-transitory computer-readable medium described herein may further include operations, features, means, or instructions for transmitting a request message requesting a quantity of CSI-RS ports associated with the one or more CSI-RS resources of the CSI-RS resource set to be enabled for beam management, where the reporting configuration indicates for the UE to measure the quantity of CSI-RS ports for the beam management.

In some examples of the method, apparatuses, and non-transitory computer-readable medium described herein, the request message includes an indication of a threshold quantity of CSI-RS ports supported by the UE for the beam management.

In some examples of the method, apparatuses, and non-transitory computer-readable medium described herein, transmitting the one or more reports may include operations, features, means, or instructions for transmitting a report including an indication of a throughput metric associated with each CSI-RS resource of the CSI-RS resource set, a reference signal received power associated with each CSI-RS resource of the CSI-RS resource set, a signal to interference and noise ratio associated with each CSI-RS resource of the CSI-RS resource set, or any combination thereof.

Some examples of the method, apparatuses, and non-transitory computer-readable medium described herein may further include operations, features, means, or instructions for performing measurements of the one or more CSI-RS resources of the CSI-RS resource set to acquire the CSI, selecting a subset of CSI-RS resources from the CSI-RS resource set based on one or more throughput metrics associated with the subset of CSI-RS resources, the one or more throughput metrics being based on the measurements, where transmitting the one or more reports includes, and transmitting a report including the CSI for the subset of CSI-RS resources, the report further including an indication of a reference signal received power associated with the subset of CSI-RS resources, a signal to interference and noise ratio associated with the subset of CSI-RS resources, or both.

Some examples of the method, apparatuses, and non-transitory computer-readable medium described herein may further include operations, features, means, or instructions for receiving a second control message indicating a configuration of one or more sounding reference signals (SRSs) associated with throughput-based beam management, where the one or more SRSs may be each associated with multiple antenna ports and transmitting the one or more SRSs based on the configuration.

Some examples of the method, apparatuses, and non-transitory computer-readable medium described herein may further include operations, features, means, or instructions for receiving one or more synchronization signal blocks (SSBs) and performing measurements of the one or more SSBs, where the beam management information may be based on the measurements, and where the beam management information includes an indication of a throughput for each beam associated with a respective SSB.

In some examples of the method, apparatuses, and non-transitory computer-readable medium described herein, each SSB of the one or more SSBs may be associated with two or more antenna ports.

In some examples of the method, apparatuses, and non-transitory computer-readable medium described herein, each beam may be associated with a first SSB occasion corresponding to a first polarization and a second SSB occasion corresponding to a second polarization different from the first polarization.

Some examples of the method, apparatuses, and non-transitory computer-readable medium described herein may further include operations, features, means, or instructions for calculating a total quantity of CSI processing units based on a first quantity of CSI processing units associated with reporting the beam management information, a second quantity of CSI processing units associated with reporting the CSI, or both and generating the beam management information, the CSI, or both, based on the total quantity of CSI processing units.

Some examples of the method, apparatuses, and non-transitory computer-readable medium described herein may further include operations, features, means, or instructions for calculating a total quantity of symbols associated with CSI processing unit occupation based on a first quantity of symbols associated with reporting the beam management information, a second quantity of symbols associated with reporting the CSI, or both and generating the beam management information, the CSI, or both, based on the total quantity of symbols.

Some examples of the method, apparatuses, and non-transitory computer-readable medium described herein may further include operations, features, means, or instructions for calculating a quantity of beam reports supported by the UE for reporting the beam management information, the quantity of beam reports being based on a threshold quantity of beam reports for beam management reporting, a threshold quantity of beam reports for CSI reporting, a threshold quantity of beam reports for throughput-based beam reporting, or any combination thereof, where transmitting the capability message includes transmitting the capability message including an indication of the quantity of beam reports, the one or more reports being based on the quantity of beam reports supported by the UE.

Some examples of the method, apparatuses, and non-transitory computer-readable medium described herein may further include operations, features, means, or instructions for receiving an indication of one or more parameters associated with uplink interference, noise, or both, per beam of a set of beams supported by the UE and selecting one or more beams for communications based on the indication of the one or more parameters.

A method for wireless communications at a network entity is described. The method may include receiving a capability message indicating a capability of a UE to support joint reporting of beam management information and CSI, transmitting a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and receiving one or more reports including the beam management information and the CSI based on the reporting configuration.

An apparatus for wireless communications at a network entity is described. The apparatus may include a memory and at least one processor of the network entity, the at least one processor coupled with the memory. The at least one processor may be configured to receive a capability message indicating a capability of a UE to support joint reporting of beam management information and CSI, transmit a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and receive one or more reports including the beam management information and the CSI based on the reporting configuration.

Another apparatus for wireless communications at a network entity is described. The apparatus may include means for receiving a capability message indicating a capability of a UE to support joint reporting of beam management information and CSI, means for transmitting a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and means for receiving one or more reports including the beam management information and the CSI based on the reporting configuration.

A non-transitory computer-readable medium storing code for wireless communications at a network entity is described. The code may include instructions executable by a processor to receive a capability message indicating a capability of a UE to support joint reporting of beam management information and CSI, transmit a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE, and receive one or more reports including the beam management information and the CSI based on the reporting configuration.

In some examples of the method, apparatuses, and non-transitory computer-readable medium described herein, receiving the capability message may include operations, features, means, or instructions for receiving the capability message including an indication of a threshold quantity of CSI-RS ports that may be supported by the UE for measuring CSI-RS resources of the CSI-RS resource set, where the reporting configuration may be based on the indication of the threshold quantity of CSI-RS ports.

### BRIEF DESCRIPTION OF THE DRAWINGS

FIG. 1 illustrates an example of a wireless communications system that supports throughput-based beam reporting techniques in accordance with one or more aspects of the present disclosure.

FIGS. 2A and 2B illustrate examples of wireless communications systems that supports throughput-based beam reporting techniques in accordance with one or more aspects of the present disclosure.

FIG. 3 illustrates an example of a wireless communications system that supports throughput-based beam reporting techniques in accordance with one or more aspects of the present disclosure.

FIG. 4 illustrates an example of a process flow in a system that supports throughput-based beam reporting techniques in accordance with one or more aspects of the present disclosure.

FIGS. 5 and 6 show block diagrams of devices that support throughput-based beam reporting techniques in accordance with one or more aspects of the present disclosure.

FIG. 7 shows a block diagram of a communications manager that supports throughput-based beam reporting techniques in accordance with one or more aspects of the present disclosure.

FIG. 8 shows a diagram of a system including a device that supports throughput-based beam reporting techniques in accordance with one or more aspects of the present disclosure.

FIGS. 9 and 10 show block diagrams of devices that support throughput-based beam reporting techniques in accordance with one or more aspects of the present disclosure.

FIG. 11 shows a block diagram of a communications manager that supports throughput-based beam reporting techniques in accordance with one or more aspects of the present disclosure.

FIG. 12 shows a diagram of a system including a device that supports throughput-based beam reporting techniques in accordance with one or more aspects of the present disclosure.

FIGS. 13 through 18 show flowcharts illustrating methods that support throughput-based beam reporting techniques in accordance with one or more aspects of the present disclosure.

### DETAILED DESCRIPTION

Some wireless communications systems may support transmission of channel state information (CSI)-reference signals (CSI-RS) for reporting beam management information and for reporting CSI. In such cases, CSI-RSs for beam management may have up to two antenna ports, and CSI-RSs for CSI reporting may have more than two antenna ports. As such, different CSI-RSs for beam management and CSI may be configured separately. Further, beam management information and CSI may be reported separately.

In some cases, a wireless device, such as a user equipment (UE) or network entity, may support decoupling of downlink and uplink beam management for enhance communications in the wireless communications system. That is, conventional selection of beam pairs (uplink and downlink beam pairs) may result in only one beam providing efficient communications between a network entity and a UE, whereas other beams may be available that provide enhanced throughput and reliability. As such, some systems may provide for decoupled beam management and selection, and a UE may select a first beam pair and a second beam pair. Here, the first beam pair may be associated with a first set of characteristics (e.g., throughput, power consumption, maximum permissible exposure (MPE), or the like) that may provide improved throughput for uplink transmissions, whereas the second beam pair may be associated with a second set of characteristics that may provide improved throughput for downlink transmissions. As such, the UE may select the first beam pair for uplink transmissions and the second beam pair for downlink transmissions. However, due to the separate configuration and separate reporting of CSI-RSs for beam management and CSI, techniques may be desirable to enable joint reporting of both beam management information and CSI to support throughput-based beam management reporting.

Accordingly, techniques described herein may support joint reporting of beam management information and CSI which may reduce reporting overhead. In some examples, the CSI-RS resource set used for both beam management and CSI reporting may be jointly configured, which may reduce configuration overhead (e.g., due to some common CSI-RS resources used for both beam measurement and CSI acquisition). In particular, a UE may transmit an indication of a capability of the UE (e.g., via a capability message) to support the joint reporting of beam management information and CSI. Based on these capabilities, the UE may receive a control message indicating a reporting configuration for jointly reporting beam management information and CSI. In some cases, the reporting configuration may indicate a single CSI-RS resource set which may include one or more CSI-RS resources that are associated with different quasi co-location (QCL) assumptions and may also be configured with multiple antenna ports for both beam measurements and CSI acquisition. The UE may transmit one or more reports including the beam management information and CSI based on the reporting configuration. In some cases, the UE may transmit a first report including the beam management information and a second report including the CSI. In some other cases, the UE may transmit a joint report including the beam management information and CSI.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to throughput-based beam reporting techniques.

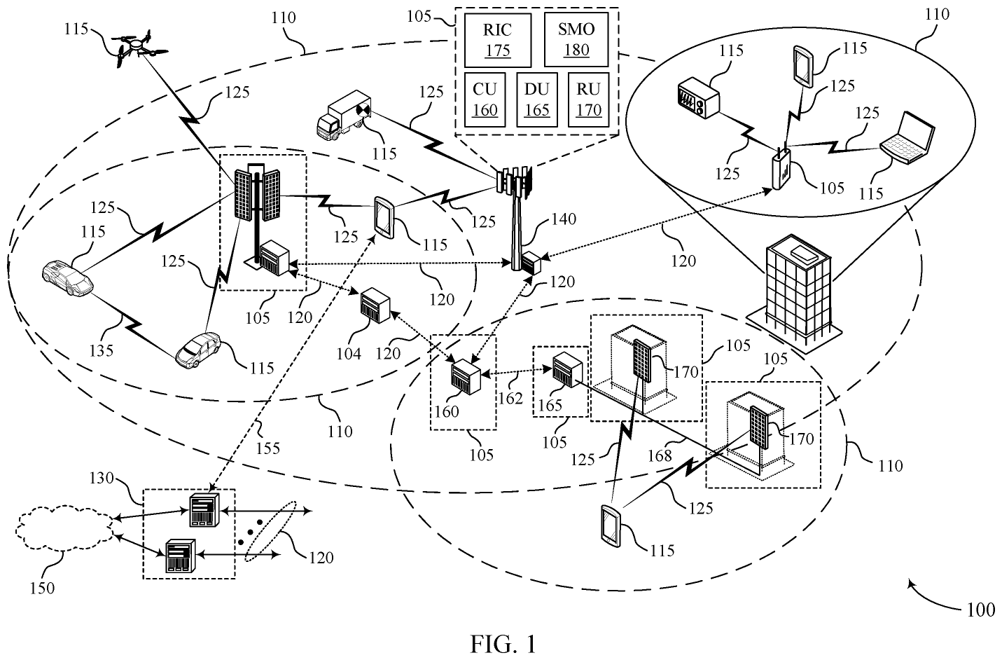

FIG. 1 illustrates an example of a wireless communications system 100 that supports throughput-based beam reporting techniques in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support throughput-based beam reporting techniques as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CCs) and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may gather channel condition information from a UE 115 to efficiently configure schedule the channel. This information may be sent from the UE 115 in the form of a channel state report (or CSI report). A channel state report may contain a rank indicator (RI) requesting a quantity of layers to be used for downlink transmissions (e.g., based on antenna ports of the UE 115), a precoding matrix indicator (PMI) indicating a preference for which precoder matrix should be used (e.g., based on a quantity of layers), and a channel quality indicator (CQI) representing a highest modulation and coding scheme (MCS) that may be used. In some cases, the RI may be associated with a quantity of antennas used by a device. CQI may be calculated by a UE 115 after receiving predetermined pilot symbols such as cell-specific reference signals (CRS) or CSI-RS. RI and PMI may be excluded if the UE 115 does not support spatial multiplexing (or is not in a supported spatial mode). In some examples, the types of information included in the CSI report determines a reporting type. Channel state reports may be periodic or aperiodic. Further, channel state reports may have different types based on a codebook used to generate the report. For instance, a Type I CSI report may be based on a first codebook and a Type II CSI report may be based on a second codebook, where the first and second codebooks may be based on different antenna configurations. In some cases, the use of either Type I or Type II CSI reports may improve MIMO performance (as compared to other types of CSI reports). In some cases, a Type II CSI report may be carried at least on a PUSCH, and may provide CSI to a network entity 105 with a relatively higher level of granularity (e.g., for MU-MIMO services).

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, one or more beam management procedures may be performed by the devices (e.g., UEs 115, network nodes 105, or the like) in wireless communications system 100. For instance, joint (e.g., simultaneous) beam sweeping performed by both a UE 115 and a network node 105 for beam selection, which may be referred to as a “P1” beam management process. With the P1 process, the network entity 105 and the UE 115 may each sweep one or more beams, and the UE 115 may select the best beam(s) (e.g., based on the beam measurement information) and report the best beams(s) to the network entity 105. A “P2” beam management process may be used for beam refinement procedures (e.g., by the network node 105). In such cases, the network node 105 may sweep one or more relatively narrow beams that the UE 115 may measure and report to the network node 105. In other examples, a “P3” beam management process may be used for beam refinement at the UE 115, in which the UE 115 may sweep one or more beams.

The wireless communications system 100 may support joint reporting of beam management information (e.g., beam measurement information) and CSI which may reduce reporting overhead and configuration overhead. In particular, a UE 115 may transmit, to a network entity 105, an indication of a capability of the UE 115 to support the joint reporting of beam management information and CSI. Based on the capabilities of the UE 115, the UE 115 may receive, from the network entity 105, a control message indicating a reporting configuration for jointly reporting beam management information and CSI. In some cases, the reporting configuration may indicate a single CSI-RS resource set which may include one or more CSI-RS resources that are associated with different QCL assumptions and may also be configured with multiple antenna ports for both beam measurements and CSI acquisition. The UE 115 may transmit one or more reports including the beam management information and CSI based on the reporting configuration. In some cases, the UE 115 may transmit a first report including the beam management information and a second report including the CSI. In some other cases, the UE 115 may transmit a joint report including the beam management information and CSI.

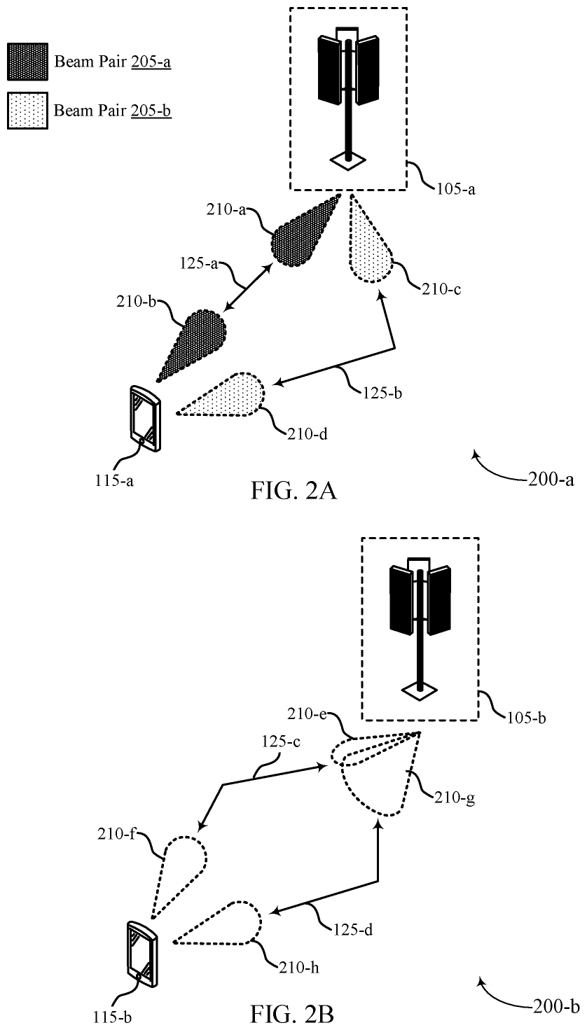

FIGS. 2A and 2B illustrate examples of wireless communications systems 200 (e.g., wireless communications system 200-a and wireless communications system 200-b) that supports throughput-based beam reporting techniques in accordance with one or more aspects of the present disclosure. In some examples, the wireless communications systems 200 may implement or be implemented by aspects of the wireless communications system 100. For example, the wireless communications systems 200 may include one or more network entities 105 (e.g., a network entity 105-a and a network entity 105-b) and one or more UEs 115 (e.g., a UE 115-a and a UE 115-b), which may be examples of the corresponding devices described with reference to FIG. 1. In the example of FIG. 2, the network entity 105-a may be examples of a CU 160, a DU 165, an RU 170, a base station 140, an IAB node 104, or one or more other network nodes as described with reference to FIG. 1. In some cases, the UE 115-a and the UE 115-b may support joint reporting of beam management information and CSI.

The wireless communications systems 200 may support transmission of channel state information CSI-RS for reporting beam management information and for reporting CSI. In such cases, CSI-RSs for beam management may have up to two antenna ports CSI-RS for CSI may have more than two antenna ports. As such, CSI-RSs for beam management and CSI may be configured and reported separately.

In some cases, a wireless device, such as a UE 115 (e.g., the UE 115-a, the UE 115-b) or a network entity 105 (e.g., the network entity 105-a, the network entity 105-b), may support decoupling of downlink and uplink beam management for enhance communications in the wireless communications systems 200. That is, some techniques for selecting beam pairs 205 (uplink and downlink beam pairs 205) may result in a first beam 210 providing efficient communications from the network entity 105 to a UE 115, whereas other beams 210 may be available that provide enhanced throughput and reliability for the uplink beam and transmissions from the UE 115 to the network entity

As such, the wireless communications systems 200 may support decoupled beam management and selection. For example, as depicted in FIG. 2A, the network entity 105-a and the UE 115-a may support multiple beam pairs, including at least a beam pair 205-a, including a beam 210-a and a beam 210-b, and a beam pair 205-b, including a beam 210-c and a beam 210-d. That is, the network entity 105-a may transmit or receive communications via the beam 210-a via a communication link 125-a and the UE 115-a may transmit or receive communications via the beam 210-a via the communication link 125-a. Additionally, the network entity 105-a may transmit or receive communications via the beam 210-c via a communication link 125-b and the UE 115-a may transmit or receive communications via the beam 210-d via the communication link 125-b.

In some cases, each beam pair 205 may be associated with a rank indicator for uplink communications and a rank indication for downlink communications, where the rank indicator indicates performance of antennas associated with the respective beam pair 205 (e.g., antennas used to transmit communications via the respective beam pair 205). In particular, the rank indicator may correspond to an indication of a quantity of transmission layers (e.g., spatial layers) for signals between a first set of one or more antennas associated with a first beam 210 in a beam pair 205, such as the beam 210-a in the beam pair 205-a, and a second set of one or more antennas associated with a second beam 210 in the beam pair 205, such as the beam 210-b in the beam pair 205-a. For example, a first rank indicator (e.g., rank 1) may indicate a single transmission layer and a second rank indicator (e.g., rank 2) may indicate multiple transmission layers.

The UE 115-a may consider rank associated with each beam pair 205 for decoupled beam management (e.g., when performing beam selection). For example, the beam pair 205-a may be associated with rank 1 for downlink communications and uplink communications while the beam pair 205-b may be associated with rank 1 for uplink communications and rank 2 for downlink communications (e.g., due to limited uplink transmission power). Additionally, the beam pair 205-a may be associated with a lower pathloss (e.g., higher link quality) than pathloss associated with the beam pair 205-b. In such cases, the UE 115-a (e.g., which may support throughput optimization for beam selection), may select the beam pair 205-a for uplink communications and the beam pair 205-b for downlink communications.

In some cases, the UE 115-a may consider MPE associated with each beam pair 205 for decoupled beam management. That is, a wireless device, such as the UE 115-a, may transmit an uplink communication at a transmit power level based on a threshold power level associated with a transmission direction (e.g., MPE). For example, the UE 115-a may transmit uplink communications via the beam 210-b in the beam pair 205-a at a first transmit power level based on a threshold power level associated with a transmit direction of the uplink communications (e.g., based on MPE). The first transmit power level may be less than a threshold (e.g., a maximum) transmit power level supported by the UE 115-a (e.g., the first transmit power level is restricted by MPE). Additionally, the UE 115-a may transmit uplink communications via the beam 210-d in the beam pair 205-b at a second transmit power level, where the second transmit power level is the maximum transmit power level supported by the UE 115-a (e.g., the second transmit power level is not restricted by MPE). In such cases, the UE 115-a may select the beam pair 205-b for uplink communications and the beam pair 205-a for downlink communications, where a downlink reference signal received power (RSRP) of the beam pair 205-a is greater than a downlink RSRP of the beam pair 205-b.

Additionally, or alternatively, the UE 115-b may support decoupled beam management for a same transmission configuration indictor (TCI) state. For example, as depicted in FIG. 2B, the network entity 105-b may support a beam 210-e and a beam 210-g and the UE 115-b may support a beam 210-f and a beam 210-h, where the beam 210-e, the beam 210-f, and the beam 210-h may be associated with a same TCI state. That is, the network entity 105-a may transmit or receive communications via the beam 210-g via a communication link 125-c and via the communication link 125-c and may transmit or receive communications via the beam 210-e via the communication link 125-c. Additionally, the UE 115-b may transmit or receive communications via the beam 210-f via the communication link 125-c and via the beam 210-h via the communication link 125-d. Additionally, the beam 210-e and the beam 210-f may be narrow beams and the beam 210-g and the beam 210-h may be wide beams.

In such cases, the UE 115-b may consider MPE, power savings, throughput, or any combination thereof for beam management. For example, (e.g., if uplink throughput is not demanding), the UE 115-b may switch from transmitting uplink communications via the beam 210-f via the communication link 125-c to transmitting uplink communications via the beam 210-h via the communication link 125-d to support power savings (e.g., if the beam 210-f does not contain the beam 210-h). In another example, the beam 210-f may be associated with MPE for downlink communications, such that the UE 115-b may select the beam 210-f (e.g., without MPE) for uplink communications. In another example, the beam 210-f may be associated with a lower throughput for uplink communications than throughput for uplink communications associated with the beam 210-h (e.g., regardless of throughput for downlink communications), such that the UE 115-b may select the beam 210-h for uplink communications.

In some cases (e.g., the network entity 105-a is communicating via the beam 210-e), the network entity 105-b may not receive communications transmitted via the beam 210-h via the communication link 125-d based on the beam 210-f being decoupled from the beam 210-h. For example, for a single TCI state associated with the beam 210-g as a QCL source, the UE 115-b may receive downlink communications via the beam 210-f but transmit uplink communications via the beam 210-h (e.g., if the beam 210-f suffers MPE). Additionally (e.g., for the single TCI state), the network entity 105-b may transmit downlink communications via the beam 210-e and receive uplink communications via the beam 210-g, such that uplink communications transmitted by the UE 115-b via the beam 210-h via the communication link 125-d may not be received by the network entity 105-b via the beam 210-h (e.g., a P2 beam). In such cases, it may be beneficial for the UE 115-b to inform the network entity 105-b that the beam 210-f and the beam 210-h are different for the single TCI state (e.g., for the beam 210-g), such that the network entity 105-b may use the beam 210-g for communicating uplink communications and downlink communications with the UE 115-b (e.g., use the same beam 210 as that for transmitting the QCL source beam 210).

As such, techniques may be desirable to enable joint reporting of both beam management information and CSI to support throughput-based beam management reporting and decoupled beam selection, which may provide for improved beam selection and beam management procedures. However, if a network entity 105 is not aware that a UE 115 supports joint beam measurement information and CSI reporting, the network entity 105 may not configure multi-port CSI-RS for reporting beam management information and may not configure CSI-RSs of different QCL assumptions for a CSI report. Thus, improved UE capability may be desirable.

Accordingly, techniques described herein may support joint reporting of beam management information and CSI which may reduce reporting overhead and configuration overhead. For example, a UE 115, such as the UE 115-a or the UE 115-b, may transmit, to a network entity 105, such as the network entity 105-a or the network entity 105-b, respectively, a capability message including an indication of a capability of the UE 115 to support the joint reporting of beam management information and CSI. Based on these capabilities, the UE 115 may receive a control message indicating a reporting configuration for jointly reporting beam management information and CSI. In some cases, the reporting configuration may indicate a single CSI-RS resource set which may include one or more CSI-RS resources that are associated with different QCL assumptions and may also be configured with multiple antenna ports for both beam measurements and CSI acquisition. The UE 115 may transmit one or more reports including the beam management information and CSI based on the reporting configuration. As an example, a report including joint beam management information (e.g., beam measurement information) and CSI may be a throughput-based beam report (e.g., where beams associated with a throughput that satisfies a threshold may be reported), a beam-optimization-based CSI report (e.g., where the CSI information is directed to beam optimization), a report of both throughput metrics and beam metrics for a same CSI-RS, or any combination thereof. In some cases, the UE 115 may transmit a first report including the beam management information and a second report including the CSI. In some other cases, the UE 115 may transmit a joint report including the beam management information and CSI.

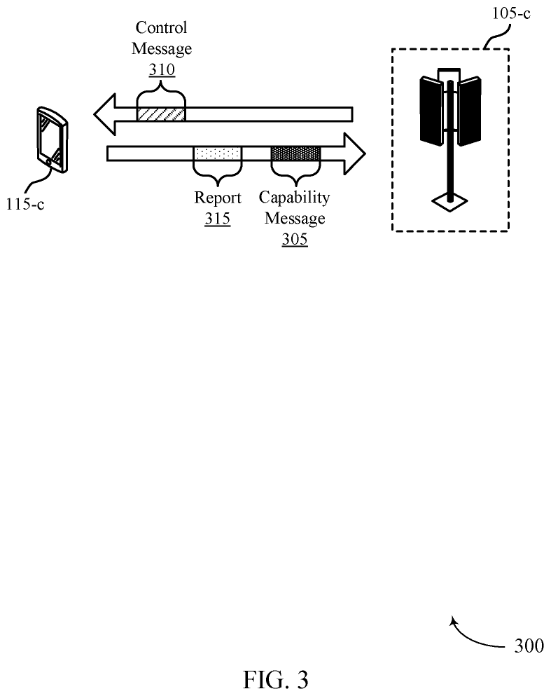

FIG. 3 illustrates an example of a wireless communications system 300 that supports throughput-based beam reporting techniques in accordance with one or more aspects of the present disclosure. In some examples, the wireless communications system 300 may implement or be implemented by aspects of the wireless communications system 100 and the wireless communications systems 200. For example, the wireless communications system 300 may include one or more network entities 105 (e.g., a network entity 105-c) and one or more UEs 115 (e.g., a UE 115-c), which may be examples of the corresponding devices described with reference to FIG. 1. In the example of FIG. 3, the network entity 105-b may be examples of a CU 160, a DU 165, an RU 170, a base station 140, an IAB node 104, or one or more other network nodes as described with reference to FIG. 1. In some cases, the UE 115-c may support joint reporting of beam management information and CSI.

In some cases, the UE 115-c may transmit, to the network entity 105-c, a capability message 305 indicating a capability of the UE 115-c to support joint reporting of beam management information and CSI (e.g., without transmission of the capability message 305, the network entity 105-c may be unaware of the ability of the UE 115-c to support joint reporting of beam management information and CSI and thus, may not configure multi-port CSI-RS for a CSI report for beam management and may not configure CSI-RSs of different QCL assumptions for a CSI report for CSI acquisition). In some cases, the UE 115-c may support performing measurements of multiple CSI-RS ports (more than two ports) of different QCL assumptions in one CSI-RS set to report quantities for beam management information and for CSI (e.g., CSI acquisition). In some cases, the capability message 305 may indicate a threshold (e.g., maximum) quantity of CSI-RS ports or a range of quantities of CSI-RS ports that are supported by the UE 115-c for measuring CSI-RS resources of a CSI-RS resource set. In some other cases, the threshold quantity of CSI-RS ports or the range of quantities of CSI-RS ports that are supported by the UE 115-c for joint reporting of the beam management information and CSI (e.g., for reporting configurations associated with reporting of the beam management information and CSI) may be indicated per BWP, per CC, for multiple CCs (e.g., per group of CCs), or any combination thereof.

In some cases, the capability message 305 may include an indication of a quantity (e.g., number) of beam reports supported by the UE 115-c for reporting beam management information. In such cases, the UE 115-c may calculate the quantity of beam reports supported by the UE 115-c for reporting beam management information based on a threshold quantity of beam reports for beam management reporting (e.g., maxNumberPeriodicCSI-PerBWP-ForBeamReport), a threshold quantity of beam reports for channel state information reporting (e.g., maxNumberPeriodicCSI-PerBWP-ForCSIReport), a threshold quantity of beam reports for throughput-based beam reporting (e.g., maxNumberPeriodicCSI-PerBWP-For TrptBeamReport), or any combination thereof (e.g., maxNumberPeriodicCSI-PerBWP-ForBeamReport and maxNumberPeriodicCSI-PerBWP-ForCSIReport).

Additionally, the UE 115-c may receive, from the network entity 105-c, a control message 310 indicating a reporting configuration for the joint reporting of beam management information and CSI based on the capability message 305 (e.g., based on the capability of the UE 115-c). In some cases, the reporting configuration may indicate a CSI-RS resource set including one or more CSI-RS resources that are associated with respective QCL assumptions.

In some examples, each CSI-RS resource may be associated with multiple antenna ports (e.g., greater than or equal to two CSI-RS ports) and may be configured without repetition and when antenna ports for CSI-RS resources are different (e.g., configured without trs-info). In such cases, the UE 115-c may perform measurements of respective CSI-RS resources of the CSI-RS resource set for acquiring beam management information (e.g., for a throughput-based report).

In some other examples, each CSI-RS resource may be associated with multiple antenna ports (e.g., greater than or equal to two CSI-RS ports) and may be configured with repetition. In such cases, the UE 115-c may perform measurements of respective CSI-RS resources of the CSI-RS resource set for acquiring CSI (e.g., for a beam-optimization based report).

In some other examples, each CSI-RS resource may be associated with multiple antenna ports (e.g., greater than or equal to two CSI-RS ports) and the UE 115-c may perform measurements of respective CSI-RS resources of the CSI-RS resource set for acquiring beam management information and CSI (e.g., a joint CSI-RS resource set can be configured for a throughput and beam-optimization based report).

The UE 115-c may transmit one or more reports 315 including the beam management information and CSI based on the reporting configuration (e.g., indicated in the control message 310). In some examples, the UE 115-c may perform measurements of respective CSI-RS resources of the CSI resource set for the beam management information and the CSI and may transmit two reports 315. That is, the UE 115-c may transmit a first report 315 including the beam management information (e.g., for the CSI-RS resource set) and a second report 315 including the CSI (e.g., for the CSI-RS resource set). In such cases, the UE 115-c may apply a first processing time (e.g., processing timeline requirement) for the first report 315 and a second processing time for the second report 315.

In some other examples, the UE 115-c may perform measurements of respective CSI-RS resources of the CSI resource set for the beam management information and the CSI and may transmit a single report 315. In some cases, the UE 115-c may transmit a single report 315 including CSI for CSI-RSs that are associated with one or more beams, where the one or more beams each satisfy a throughput threshold based on the measurements (e.g., the UE 115-c may report beams above a threshold). For example, the UE 115-c may transmit a single report 315 including CSI for CSI-RSs that are associated with one or more beams that satisfy a channel quality indicator (CQI) threshold, a throughput threshold, or both. Additionally, or alternatively, the single report 315 may include multiple report quantities (e.g., two report quantities). For example, the single report 315 may include a first report quantity associated with beam management information and a second report quantity associated with CSI. That is, the first report may include a first CSI-RS resource identifier value and a reference signal received power (RSRP) value (e.g., cri-RSRP) and the second report may include a second CSI-RS resource identifier value, a rank indicator (RI) value, a precoding matrix indicator (PMI) value, a CQI value, or any combination thereof (e.g., cri-RI-PMI-CQI). In some other cases, the single report 315 may include a joint report quantity associated with beam management information and CSI. For example, the single report 315 may include the joint report quantity including a CSI-RS resource identifier value, an RSRP value, an RI value, a PMI value, a CQI value, or any combination thereof (e.g., cri-RSRP-RI-PMI-CQI). In some cases, the RSRP value, the RI value, the PMI value, the CQI value, or any combination thereof, may be based on the CSI-RS resource identifier value. Additionally, or alternatively, the one or more reports 315 may include an indication of a throughput metric, an RSRP associated with each CSI-RS resource of the CSI-RS resource set, a signal to interference and noise ratio (SINR) associated with each CSI-RS resource of the CSI-RS resource set, or any combination thereof.

Additionally, or alternatively, the UE 115-c may request a quantity of CSI-RS ports associated with the one or more resources of the CSI-RS resource set to be enabled for beam management (e.g., CSI-RS for beam management), such that the reporting configuration may indicate for the UE 115-c to measure the requested quantity of CSI-RS ports for beam management. In some cases, the UE 115-a may transmit the request via uplink control information (UCI), MAC-control element (MAC-CE), UE assistance information, or the like. Additionally, or alternatively, the request may indicate a threshold (e.g., maximum) quantity of CSI-RS ports supported by the UE 115-c for beam management.

In some aspects, the UE 115-c may perform measurements of the one or more CSI-RS resources of the CSI-RS resource set to acquire CSI (e.g., CSI-RS for CSI) for throughput-based beam management. In such case, the UE 115-c may select a subset of CSI-RS resources from the CSI-RS resource set based on one or more throughput metrics associated with the subset (e.g., the UE 115-c may select the reported CSI-RS resources based on a throughput metric estimated via a corresponding CSI-RS). Further, the UE 115-c may transmit the report 315 including CSI for the subset of CSI-RS resources, where the report 315 includes an L1-RSRP associated with each CSI-RS resource in the subset of CSI-RS resources, or an L1-SINR associated with the subset of CSI-RS resources. In some examples, a reported metric may be an LI-RSRP or an LI-SINR, and the UE 115-c may select the reported reference signal(s) based on a downlink throughput, an uplink throughput, or both, estimated via the corresponding CSI-RS. In such cases, the UE 115-c may report a quantity of reference signals (e.g., N reference signals) with a relatively highest downlink throughput (e.g., a highest-N throughput) or a relatively highest uplink throughput (e.g., a highest-N throughput) and report the corresponding L1-RSRP or L1-SINR information for each reference signal. In another example, the UE may report the N reference signals with the relatively highest downlink throughput or the N reference signals with the relatively highest uplink throughput, as well as the respective highest throughput values (e.g., highest-N uplink/downlink throughput) and the corresponding L1-RSRPor L1-SINR information. The UE 115-c may be configured, for example, using a dedicated indication (e.g., in a reporting configuration), that the beam report is downlink throughput-based or uplink throughput-based.

In some other cases, the UE 115-c may receive a second control message 310 indicating a configuration of one or more sounding reference signals (SRSs) associated with throughput-based beam management, where each SRS is associated with multiple antenna ports (e.g., multi-port SRS). In such cases, the UE 115-c may transmit the one or more SRSs based on the configuration.

In some cases (e.g., to facilitate throughout-based beam management for joint network entity 105-c and UE 115-c beam sweeping), the UE 115-c may support reception of synchronization signal blocks (SSBs) each associated with two or more antenna ports (e.g., multi-port SSB) such that the UE 115-c may report a throughput metric per SSB (e.g., in green field deployment). That is, the UE 115-c may receive one or more SSBs and may perform measurements of the one or more SSBs, such that beam management information reported in the one or more reports 315 may be based on the measurements. In some cases, the beam management information may include an indication of a throughput for each beam associated with a respective SSB. Additionally, each beam may be associated with a first SSB occasion (e.g., FDM or TDM SSB occasion) corresponding to a first polarization (e.g., H polarization port) and a second SSB occasion corresponding to a second polarization (e.g., V polarization port) different from the first polarization (e.g., one SSB occasion may be visible to non-joint reporting UEs 115 and both SSB occasions may be visible to the UE 115-c for throughput estimation).

In some cases, (e.g., for a throughput-based beam report) the UE 115-c may calculate (e.g., count) a quantity of CSI processing units (e.g., a total quantity of CSI processing units). The quantity of CSI processing units may be based on a first quantity of CSI processing units associated with reporting the beam management information (e.g., legacy beam report, throughput-based beam report), a second quantity of CSI processing units associated with reporting the CSI (e.g., legacy CSI report for CSI acquisition), or both. For example, a total quantity of calculated CSI processing units may be equal to a greatest (e.g., maximum) quantity of CSI processing units out of the first quantity or the second quantity. In another example, the quantity of calculated CSI processing units may be equal to the first quantity in addition to the second quantity.

In some cases (e.g., a throughput-based beam report), the UE 115-c may calculate (e.g., count) a total quantity of symbols associated with CSI processing unit occupation (e.g., where different quantities of symbols Z1, Z1′, Z2, Z2′, Z3, and Z3′ may correspond to CSI computation delay requirements). Additionally, the symbols may be based on a first quantity of symbols associated with reporting the beam management information (e.g., legacy beam report, throughput-based beam report), a second quantity of symbols associated with reporting the CSI (e.g., legacy CSI report for throughput), or both. For example, the total quantity of calculated symbols may be equal to a greatest (e.g., maximum) quantity of symbols out of the first quantity or the second quantity. In another example, the total quantity of calculated symbols may be equal to the first quantity in addition to the second quantity.

In some cases, the UE 115-c may receive a third control message 310 indicating statistics and/or one or more parameters (e.g., average/filtered, minimum/maximum, percentage of samples across time) associated with uplink interference, noise, or both, per beam of a set of beams supported by the UE 115-c, such that the UE 115-c may select one or more beams for communications based on the indication of the one or more parameters (e.g., optimal rank may be reduced for beams associated with higher interference levels). In some cases, the network entity 105-c may transmit the third control message based on receiving the capability message 305. In other examples, the third control message 310 may be transmitted when uplink throughput-based beam selection is enabled, separate downlink and uplink beam reports are enabled, upon UE 115-c request, or any combination thereof.

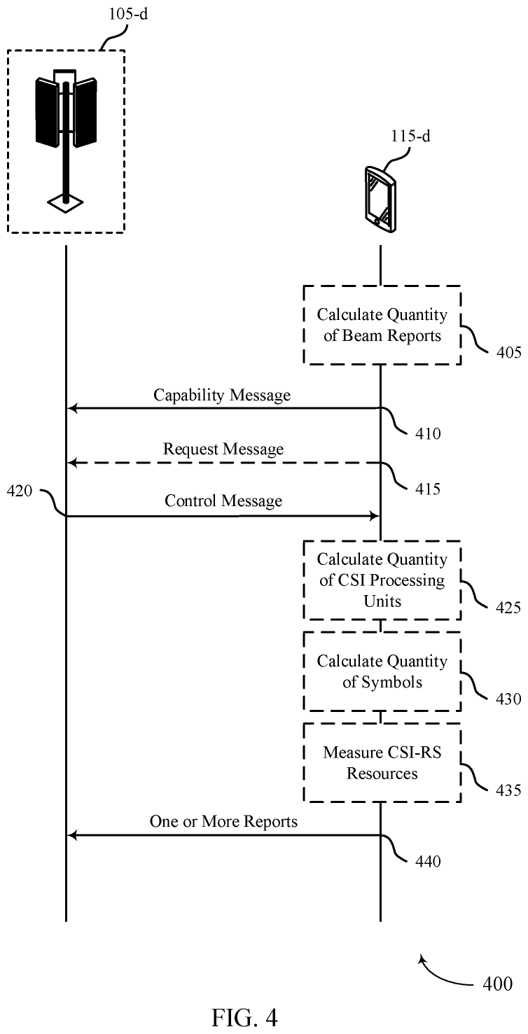

FIG. 4 illustrates an example of a process flow 400 in a system that supports throughput-based beam reporting techniques in accordance with one or more aspects of the present disclosure. In some examples, the process flow 400 may implement or be implemented by aspects of the wireless communications system 100, the wireless communications systems 200, and the wireless communications system 300. For example, the process flow 400 may include one or more network entities 105 (e.g., a network entity 105-d) and one or more UEs 115 (e.g., a UE 115-d), which may be examples of the corresponding devices described with reference to FIG. 1. In the example of FIG. 4, the network entity 105-c may be examples of a CU 160, a DU 165, an RU 170, a base station 140, an IAB node 104, or one or more other network nodes as described with reference to FIG. 1. In some cases, the UE 115-d may transmit one or more reports including beam management information and CSI based on receiving a reporting configuration for joint reporting.

In some cases, at 405, the UE 115-d may calculate a quantity of beam reports supported by the UE 115-d for reporting beam management information. The quantity of beam reports may be based on a threshold quantity of beam reports for beam management reporting, a threshold quantity of beam reports for CSI reporting, a threshold quantity of beam reports for throughput-based beam reporting, or any combination thereof.

In some cases, the UE 115-d may receive, from the network entity 105-d, an indication of one or more parameters associated with uplink interference, noise, or both, per beam of a set of beams supported by the UE 115-d. The UE 115-d may select one or more beams for communications (e.g., with the network entity 105-d) based on the indication of the one or more parameters.

At 410, the UE 115-d may transmit, to the network entity 105-d, a capability message indicating a capability of the UE 115-d to support joint reporting of beam management information and CSI. In some cases, the capability message may include an indication of the quantity of beam reports supported by the UE 115-d.

In some cases, the capability message may include an indication of a threshold quantity of CSI-RS ports that are supported by the UE 115-d for measuring CSI-RS resources of a CSI-RS resource set, where the threshold quantity of CSI-RS ports includes a quantity of CSI-RS ports that are supported by the UE 115-d for a set of reporting configurations for the joint reporting of the beam management information and the CSI. In some cases, the threshold quantity of CSI-RS ports may be indicated per BWP, per CC, for a multiple CCs, or any combination thereof.

In some other cases, the capability message may include an indication of a range of quantities of CSI-RS ports that are supported by the UE 115-d for measuring CSI-RS resources of the CSI-RS resource set, where the range of quantities of CSI-RS ports includes a quantity of CSI-RS ports that are supported by the UE 115-d for the set of reporting configurations for the joint reporting of the beam management information and the CSI. In some cases, the range of quantities of CSI-RS ports may be indicated per BWP, per CC, for a multiple CCs, or any combination thereof.

In some cases, at 415, the UE 115-d may transmit, to the network entity 105-d, a request message requesting a quantity of CSI-RS ports associated with the one or more CSI-RS resources of the CSI-RS resource set to be enabled for beam management. Additionally, the request message may include an indication of a threshold (e.g., maximum) quantity of CSI-RS ports supported by the UE 115-d for beam management.

At 420, the UE 115-d may receive, from the network entity 105-d, a control message indicating a reporting configuration for the joint reporting of the beam management information and the CSI, the reporting configuration indicating the CSI-RS resource set including one or more CSI-RS resources that are associated with respective QCL assumptions, where the reporting configuration is based on the capability of the UE 115-d. In some cases, the reporting configuration may indicate for the UE 115-d to measure the requested quantity of CSI-RS ports for beam management.

In some cases, the UE 115-d may receive a second control message indicating a configuration of one or more SRSs associated with throughput-based beam management, where the one or more sounding reference signals are each associated with multiple antenna ports. The UE 115-d may transmit the one or more SRSs based on the configuration.

In some cases, at 425, the UE 115-d may calculate a total quantity of CSI processing units based on a first quantity of CSI processing units associated with reporting the beam management information, a second quantity of CSI processing units associated with reporting the channel state information, or both. The UE 115-d may generate the beam management information, the CSI, or both, based on the total quantity of CSI processing units.

In some cases, at 430, the UE 115-d may calculate a total quantity of symbols associated with CSI processing unit occupation based on a first quantity of symbols associated with reporting the beam management information, a second quantity of symbols associated with reporting the channel state information, or both. The UE 115-d may generate the beam management information, the CSI, or both, based on the total quantity of symbols.

In some cases, at 435, the UE 115-d may perform measurements of respective CSI-RS resources of the CSI-RS resource set for acquiring the beam management information, where the respective CSI-RS resources are each associated with multiple antenna ports. In such cases, the respective CSI-RS resources may be configured without repetition and may each be associated with different antenna ports.

In some other cases, the UE 115-d may perform measurements of respective CSI-RS resources of the CSI-RS resource set for acquiring the CSI, where the respective CSI-RS resources are each associated with multiple antenna ports. In such cases, the respective CSI-RS resources may be configured with repetition.

In some other cases, the UE 115-d may perform measurements of respective CSI-RS resources of the CSI-RS resource set for acquiring the beam management information and the CSI, where the respective CSI-RS resources are each associated with multiple antenna ports.

In some cases, the UE 115-d may receive one or more SSBs and may perform measurements of the one or more SSBs. As such, the beam management information may be based on the measurements and may include an indication of a throughout for each beam associated with a respective SSB. Each SSB of the one or more SSBs may be associated with two or more antenna ports and each beam may be associated with a first SSB occasion corresponding to a first polarization and a second SSB occasion corresponding to a second polarization different from the first polarization.

At 440, the UE 115-d may transmit, to the network entity 105-d, one or more reports including the beam management information and the CSI based on the reporting configuration. In some cases, the one or more reports may be based on the quantity of beam reports supported by the UE 115-d.

In some cases, the UE 115-d may transmit (e.g., based on the measurements) a first report including the beam management information and a second report include the CSI. Alternatively, the UE 115-d may transmit one report including beam management information, CSI, or both. For example, the UE 115-d may transmit a report including CSI for CSI-RSs that are associated with one or more beams, where the one or more beams each satisfy a throughout threshold (e.g., based on the measurements). In another example, the UE 115-d may transmit a report including a first report quantity associated with the beam management information and a second report quantity associated with the CSI. In such cases, the first report quantity may include a first CSI-RS resource identifier value and an RSRP value and the second report quantity may include a second CSI-RS resource identifier value, an RI value, a PMI value, a CQI value, or any combination thereof. In another example, the UE 115-d may transmit a report including a joint report quantity associated with the beam management information and the CSI. In such cases, the joint report quantity may include a CSI-RS resource identifier value, an RSRP value, an RI value, a PMI value, a CQI value, or any combination thereof.

In some cases, the one or more reports may include an indication of a throughput metric associated with each CSI-RS resource of the CSI-RS resource set, an RSRP associated with each CSI-RS resource of the CSI-RS resource set, an SINR associated with each CSI-RS resource of the CSI-RS resource set, or any combination thereof.

In some cases, the UE 115-d may select a subset of CSI-RS resources from the CSI-RS resource set based on one or more throughput metrics associated with the subset of CSI-RS resources (e.g., based on the measurements), such that the UE 115-d may transmit a report including the CSI for the subset of CSI-RS resources. In such cases, the report may include an indication of an RSRP associated with the subset of CSI-RS resources, an SINR associated with the subset of CSI-RS resources, or both.

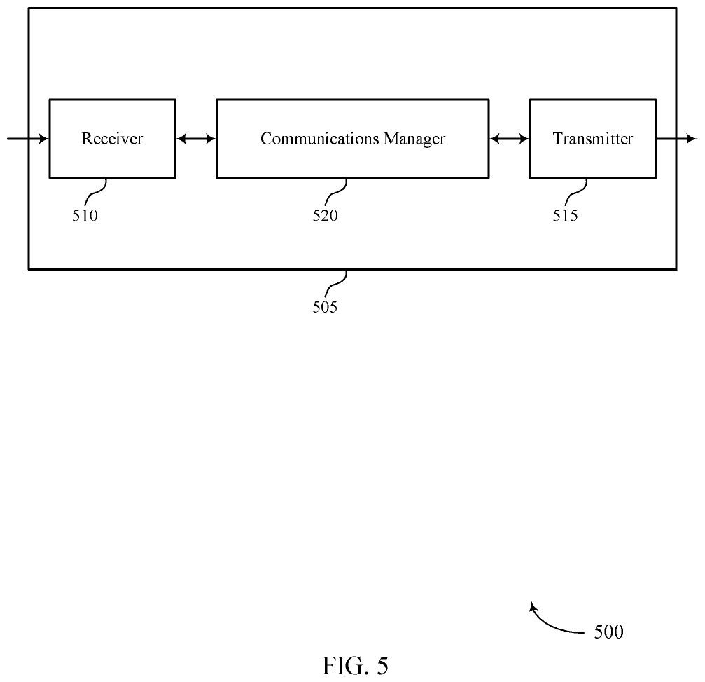

FIG. 5 shows a block diagram 500 of a device 505 that supports throughput-based beam reporting techniques in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to throughput-based beam reporting techniques). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to throughput-based beam reporting techniques). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of throughput-based beam reporting techniques as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may be configured to receive or transmit messages or other signaling as described herein via a transceiver 815. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for transmitting a capability message indicating a capability of the UE to support joint reporting of beam management information and CSI. The communications manager 520 may be configured as or otherwise support a means for receiving a control message indicating a reporting configuration for the joint reporting of the beam management information and the CSI, the reporting configuration indicating a CSI-RS resource set including one or more CSI-RS resources that are associated with respective QCL assumptions, where the reporting configuration is based on the capability of the UE. The communications manager 520 may be configured as or otherwise support a means for transmitting one or more reports including the beam management information and CSI based on the reporting configuration.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for joint reporting of beam management information and CSI which may result in reduced processing, reduced power consumption, and more efficient utilization of communication resources, among other advantages.

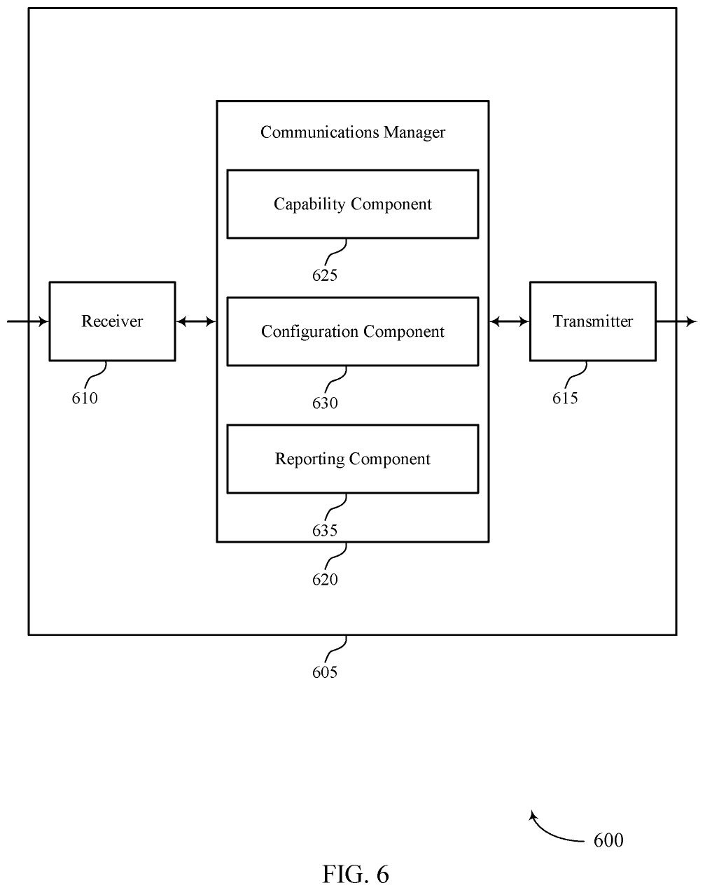

FIG. 6 shows a block diagram 600 of a device 605 that supports throughput-based beam reporting techniques in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to throughput-based beam reporting techniques). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to throughput-based beam reporting techniques). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of throughput-based beam reporting techniques as described herein. For example, the communications manager 620 may include a capability component 625, a configuration component 630, a reporting component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may be configured to receive or transmit messages or other signaling as described herein via the transceiver 815. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The capability component 625 may be configured as or otherwise support a means for transmitting a capability message indicating a capability of the UE to support joint reporting of beam management information and CSI. The configuration component 630 may be configured as or otherwise support a means for receiving a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The reporting component 635 may be configured as or otherwise support a means for transmitting one or more reports including the beam management information and CSI based on the reporting configuration.

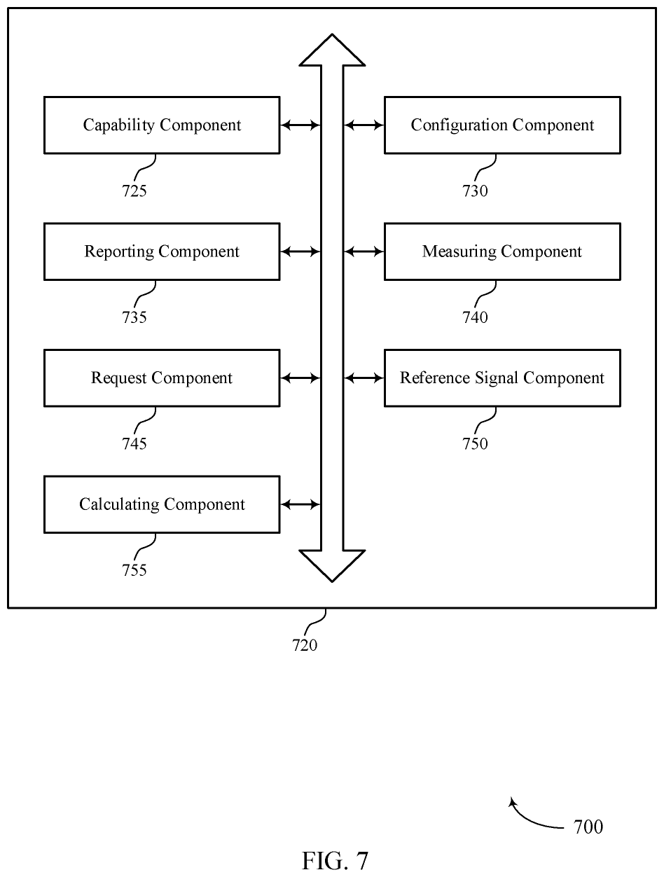

FIG. 7 shows a block diagram 700 of a communications manager 720 that supports throughput-based beam reporting techniques in accordance with one or more aspects of the present disclosure. The communications manager 720 may be an example of aspects of a communications manager 520, a communications manager 620, or both, as described herein. The communications manager 720, or various components thereof, may be an example of means for performing various aspects of throughput-based beam reporting techniques as described herein. For example, the communications manager 720 may include a capability component 725, a configuration component 730, a reporting component 735, a measuring component 740, a request component 745, a reference signal component 750, a calculating component 755, or any combination thereof. Each of these components may communicate, directly or indirectly, with one another (e.g., via one or more buses).

The communications manager 720 may support wireless communications at a UE in accordance with examples as disclosed herein. The capability component 725 may be configured as or otherwise support a means for transmitting a capability message indicating a capability of the UE to support joint reporting of beam management information and CSI. The configuration component 730 may be configured as or otherwise support a means for receiving a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The reporting component 735 may be configured as or otherwise support a means for transmitting one or more reports including the beam management information and CSI based on the reporting configuration.

In some examples, to support transmitting the capability message, the capability component 725 may be configured as or otherwise support a means for transmitting the capability message including an indication of a threshold quantity of CSI-RS ports that are supported by the UE for measuring CSI-RS resources of the CSI-RS resource set, where the reporting configuration is based on the indication of the threshold quantity of CSI-RS ports.

In some examples, the threshold quantity of CSI-RS ports includes a quantity of CSI-RS ports that are supported by the UE for a set of multiple reporting configurations for the joint reporting of the beam management information and the CSI, the threshold quantity of CSI-RS ports being indicated per BWP, per CC, for a set of multiple CCs, or any combination thereof.

In some examples, to support transmitting the capability message, the capability component 725 may be configured as or otherwise support a means for transmitting the capability message including an indication of a range of quantities of CSI-RS ports supported by the UE for measuring CSI-RS resources of the CSI-RS resource set, where the reporting configuration is based on the indication of the range of quantities of CSI-RS ports.

In some examples, the range of quantities of CSI-RS ports includes a range of quantities of CSI-RS ports that are supported by the UE for set of multiple reporting configurations for the joint reporting of the beam management information and the CSI, the range of quantities of CSI-RS ports being indicated per BWP, per CC, for a set of multiple CCs, or any combination thereof.

In some examples, the measuring component 740 may be configured as or otherwise support a means for performing measurements of respective CSI-RS resources of the CSI-RS resource set for acquiring the beam management information, where the respective CSI-RS resources are each associated with a set of multiple antenna ports, the respective CSI-RS resources being configured without repetition and are each associated with different antenna ports.

In some examples, the measuring component 740 may be configured as or otherwise support a means for performing measurements of respective CSI-RS resources of the CSI-RS resource set for acquiring the CSI, where the respective CSI-RS resources are each associated with a set of multiple antenna ports, the respective CSI-RS resources being configured with repetition.

In some examples, the measuring component 740 may be configured as or otherwise support a means for performing measurements of respective CSI-RS resources of the CSI-RS resource set for acquiring the beam management information and the CSI, where the respective CSI-RS resources are each associated with a set of multiple antenna ports.

In some examples, the measuring component 740 may be configured as or otherwise support a means for performing measurements of the one or more CSI-RS resources of the CSI-RS resource set for acquiring the beam management information and the CSI, where transmitting the one or more reports includes. In some examples, the reporting component 735 may be configured as or otherwise support a means for transmitting, based on the measurements, a first report including the beam management information and a second report including the CSI.

In some examples, the measuring component 740 may be configured as or otherwise support a means for performing measurements of the one or more CSI-RS resources of the CSI-RS resource set for acquiring the beam management information and CSI, where transmitting the one or more reports includes. In some examples, the reporting component 735 may be configured as or otherwise support a means for transmitting a report including CSI for CSI-RSs that are associated with one or more beams, the one or more beams each satisfying a throughput threshold based on the measurements.

In some examples, the measuring component 740 may be configured as or otherwise support a means for performing measurements of the one or more CSI-RS resources of the CSI-RS resource set for acquiring the beam management information and CSI, where transmitting the one or more reports includes. In some examples, the reporting component 735 may be configured as or otherwise support a means for transmitting a report including a first report quantity associated with the beam management information and a second report quantity associated with the CSI.

In some examples, the first report quantity includes a first CSI-RS resource identifier value and a reference signal received power value. In some examples, the second report quantity includes a second CSI-RS resource identifier value, a rank indicator value, a precoding matrix indicator value, a channel quality indicator value, or any combination thereof.

In some examples, the measuring component 740 may be configured as or otherwise support a means for performing measurements of the one or more CSI-RS resources of the CSI-RS resource set for acquiring the beam management information and the CSI, where transmitting the one or more reports includes. In some examples, the reporting component 735 may be configured as or otherwise support a means for transmitting a report including a joint report quantity associated with the beam management information and the CSI.

In some examples, the joint report quantity includes a CSI-RS resource identifier value, a reference signal received power value, a rank indicator value, a precoding matrix indicator value, a channel quality indicator value, or any combination thereof.

In some examples, the request component 745 may be configured as or otherwise support a means for transmitting a request message requesting a quantity of CSI-RS ports associated with the one or more CSI-RS resources of the CSI-RS resource set to be enabled for beam management, where the reporting configuration indicates for the UE to measure the requested quantity of CSI-RS ports for the beam management.

In some examples, the request message includes an indication of a threshold quantity of CSI-RS ports supported by the UE for the beam management.

In some examples, to support transmitting the one or more reports, the reporting component 735 may be configured as or otherwise support a means for transmitting a report including an indication of a throughput metric associated with each CSI-RS resource of the CSI-RS resource set, a reference signal received power associated with each CSI-RS resource of the CSI-RS resource set, a signal to interference and noise ratio associated with each CSI-RS resource of the CSI-RS resource set, or any combination thereof.

In some examples, the measuring component 740 may be configured as or otherwise support a means for performing measurements of the one or more CSI-RS resources of the CSI-RS resource set to acquire the CSI. In some examples, the measuring component 740 may be configured as or otherwise support a means for selecting a subset of CSI-RS resources from the CSI-RS resource set based on one or more throughput metrics associated with the subset of CSI-RS resources, the one or more throughput metrics being based on the measurements, where transmitting the one or more reports includes. In some examples, the reporting component 735 may be configured as or otherwise support a means for transmitting a report including the CSI for the subset of CSI-RS resources, the report further including an indication of a reference signal received power associated with the subset of CSI-RS resources, a signal to interference and noise ratio associated with the subset of CSI-RS resources, or both.

In some examples, the configuration component 730 may be configured as or otherwise support a means for receiving a second control message indicating a configuration of one or more SRSs associated with throughput-based beam management, where the one or more SRSs are each associated with multiple antenna ports. In some examples, the reference signal component 750 may be configured as or otherwise support a means for transmitting the one or more SRSs based on the configuration.

In some examples, the measuring component 740 may be configured as or otherwise support a means for receiving one or more SSBs. In some examples, the measuring component 740 may be configured as or otherwise support a means for performing measurements of the one or more SSBs, where the beam management information is based on the measurements, and where the beam management information includes an indication of a throughput for each beam associated with a respective SSB.

In some examples, each SSB of the one or more SSBs is associated with two or more antenna ports.

In some examples, each beam is associated with a first SSB occasion corresponding to a first polarization and a second SSB occasion corresponding to a second polarization different from the first polarization.

In some examples, the calculating component 755 may be configured as or otherwise support a means for calculating a total quantity of CSI processing units based on a first quantity of CSI processing units associated with reporting the beam management information, a second quantity of CSI processing units associated with reporting the CSI, or both. In some examples, the reporting component 735 may be configured as or otherwise support a means for generating the beam management information, the CSI, or both, based on the total quantity of CSI processing units.

In some examples, the calculating component 755 may be configured as or otherwise support a means for calculating a total quantity of symbols associated with CSI processing unit occupation based on a quantity of symbols associated with reporting the beam management information, associated with reporting the CSI, or both. In some examples, the reporting component 735 may be configured as or otherwise support a means for generating the beam management information, the CSI, or both, based on the total quantity of symbols.

In some examples, the calculating component 755 may be configured as or otherwise support a means for calculating a quantity of beam reports supported by the UE for reporting the beam management information, the quantity of beam reports being based on a threshold quantity of beam reports for beam management reporting, a threshold quantity of beam reports for CSI reporting, a threshold quantity of beam reports for throughput-based beam reporting, or any combination thereof, where transmitting the capability message includes transmitting the capability message including an indication of the quantity of beam reports, the one or more reports being based at least in part on the quantity of beam reports supported by the UE. In some examples, the reporting component 735 may be configured as or otherwise support a means for transmitting the message including an indication of the quantity of beam reports, the one or more reports being based on the quantity of beam reports supported by the UE.

In some examples, the configuration component 730 may be configured as or otherwise support a means for receiving an indication of one or more parameters associated with uplink interference, noise, or both, per beam of a set of beams supported by the UE. In some examples, the reporting component 735 may be configured as or otherwise support a means for selecting one or more beams for communications based on the indication of the one or more parameters.

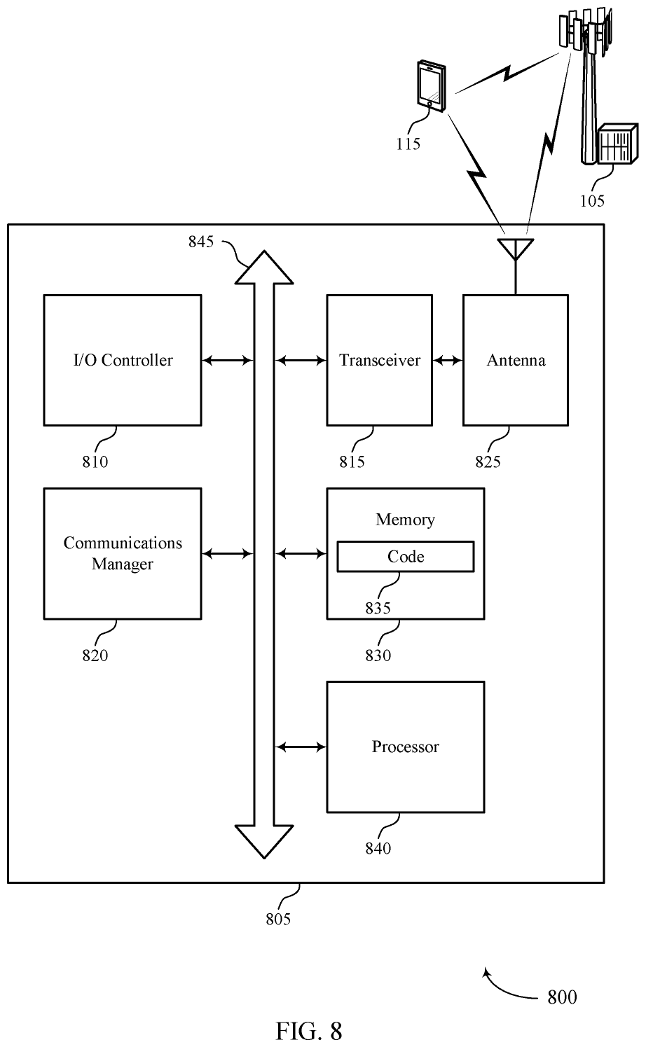

FIG. 8 shows a diagram of a system 800 including a device 805 that supports throughput-based beam reporting techniques in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, the transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting throughput-based beam reporting techniques). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting a capability message indicating a capability of the UE to support joint reporting of beam management information and CSI. The communications manager 820 may be configured as or otherwise support a means for receiving a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The communications manager 820 may be configured as or otherwise support a means for transmitting one or more reports including the beam management information and CSI based on the reporting configuration.

By including or configuring the communications manager 820 in accordance with examples as described herein, the device 805 may support techniques for joint reporting of beam management information and CSI which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of throughput-based beam reporting techniques as described herein, or the processor 840 and the memory 830 may be otherwise configured to perform or support such operations.

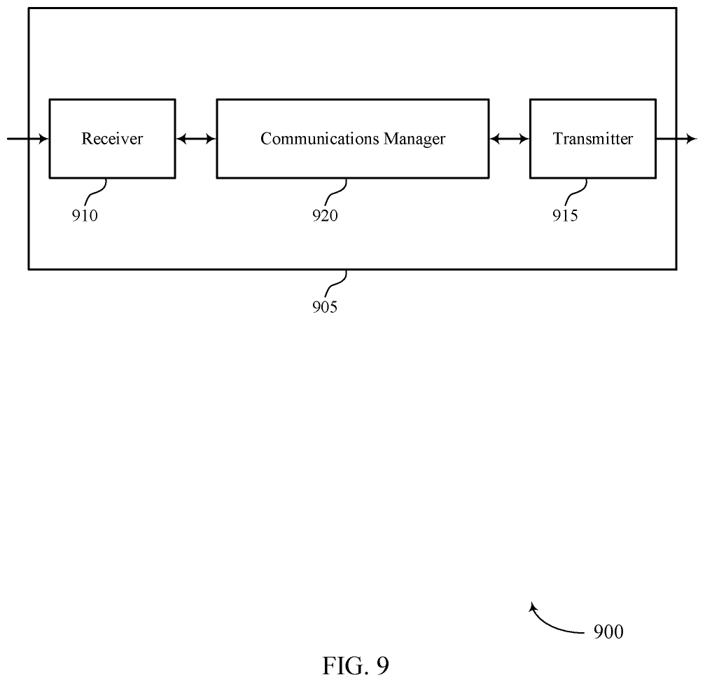

FIG. 9 shows a block diagram 900 of a device 905 that supports throughput-based beam reporting techniques in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of throughput-based beam reporting techniques as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 520 may be configured to receive or transmit messages or other signaling as described herein via a transceiver 1210. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for receiving a capability message indicating a capability of a UE to support joint reporting of beam management information and CSI. The communications manager 920 may be configured as or otherwise support a means for transmitting a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The communications manager 920 may be configured as or otherwise support a means for receiving one or more reports including the beam management information and the CSI based on the reporting configuration.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for joint reporting of beam management information and CSI which may result in reduced processing, reduced power consumption, and more efficient utilization of communication resources, among other advantages.

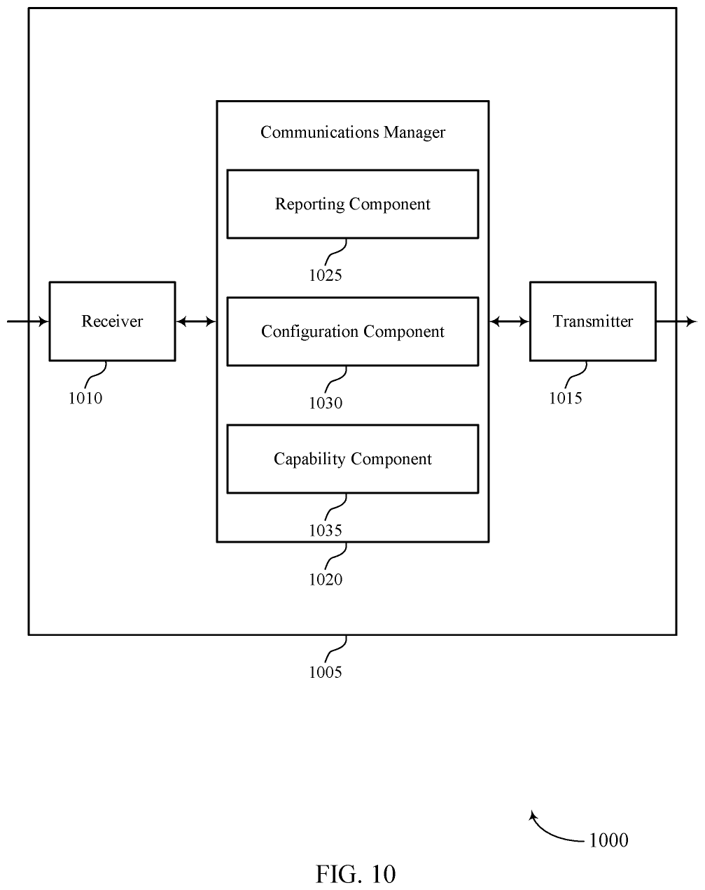

FIG. 10 shows a block diagram 1000 of a device 1005 that supports throughput-based beam reporting techniques in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of throughput-based beam reporting techniques as described herein. For example, the communications manager 1020 may include a reporting component 1025, a configuration component 1030, a capability component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 520 may be configured to receive or transmit messages or other signaling as described herein via the transceiver 1210. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The reporting component 1025 may be configured as or otherwise support a means for receiving a capability message indicating a capability of a UE to support joint reporting of beam management information and CSI. The configuration component 1030 may be configured as or otherwise support a means for transmitting a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The capability component 1035 may be configured as or otherwise support a means for receiving one or more reports including the beam management information and the CSI based on the reporting configuration.

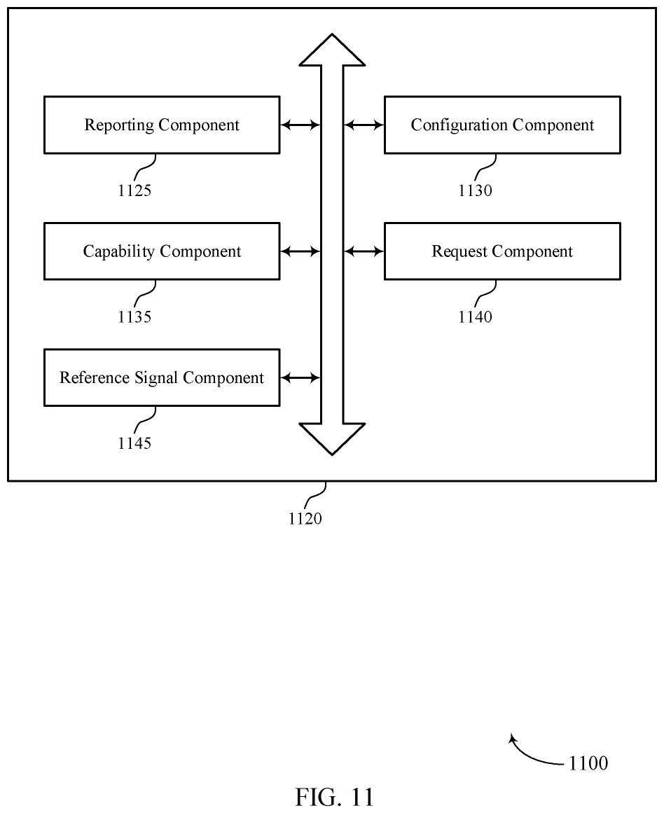

FIG. 11 shows a block diagram 1100 of a communications manager 1120 that supports throughput-based beam reporting techniques in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of throughput-based beam reporting techniques as described herein. For example, the communications manager 1120 may include a reporting component 1125, a configuration component 1130, a capability component 1135, a request component 1140, a reference signal component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The reporting component 1125 may be configured as or otherwise support a means for receiving a capability message indicating a capability of a UE to support joint reporting of beam management information and CSI. The configuration component 1130 may be configured as or otherwise support a means for transmitting a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The capability component 1135 may be configured as or otherwise support a means for receiving one or more reports including the beam management information and the CSI based on the reporting configuration.

In some examples, to support receiving the capability message, the capability component 1135 may be configured as or otherwise support a means for receiving the capability message including an indication of a threshold quantity of CSI-RS ports that are supported by the UE for measuring CSI-RS resources of the CSI-RS resource set, where the reporting configuration is based on the indication of the threshold quantity of CSI-RS ports.

In some examples, the threshold quantity of CSI-RS ports includes a quantity of CSI-RS ports that are supported by the UE for a set of multiple reporting configurations for the joint reporting of the beam management information and the CSI, the threshold quantity of CSI-RS ports being indicated per BWP, per CC, for a set of multiple CCs, or any combination thereof.

In some examples, to support receiving the capability message, the capability component 1135 may be configured as or otherwise support a means for receiving the capability message including an indication of a range of quantities of CSI-RS ports supported by the UE for measuring CSI-RS resources of the CSI-RS resource set, where the reporting configuration is based on the indication of the range of quantities of CSI-RS ports.

In some examples, the range of quantities of CSI-RS ports includes a range of quantities of CSI-RS ports that are supported by the UE for set of multiple reporting configurations for the joint reporting of the beam management information and the CSI, the range of quantities of CSI-RS ports being indicated per BWP, per CC, for a set of multiple CCs, or any combination thereof.

In some examples, to support receiving the one or more reports, the reporting component 1125 may be configured as or otherwise support a means for receiving a first report including the beam management information and a second report including the CSI.

In some examples, to support receiving the one or more reports, the reporting component 1125 may be configured as or otherwise support a means for receiving a report including CSI for CSI-RSs that are associated with one or more beams, the one or more beams each satisfying a throughput threshold.

In some examples, to support receiving the one or more reports, the reporting component 1125 may be configured as or otherwise support a means for receiving a report including a first report quantity associated with the beam management information and a second report quantity associated with the CSI.

In some examples, the first report quantity includes a first CSI-RS resource identifier value and a reference signal received power value. In some examples, the second report quantity includes a second CSI-RS resource identifier value, a rank indicator value, a precoding matrix indicator value, a channel quality indicator value, or any combination thereof.

In some examples, to support receiving the one or more reports, the reporting component 1125 may be configured as or otherwise support a means for receiving a report including a joint report quantity associated with the beam management information and the CSI.

In some examples, the joint report quantity includes a CSI-RS resource identifier value, a reference signal received power value, a rank indicator value, a precoding matrix indicator value, a channel quality indicator value, or any combination thereof.

In some examples, the request component 1140 may be configured as or otherwise support a means for receiving a request message requesting a quantity of CSI-RS ports associated with the one or more CSI-RS resources of the CSI-RS resource set to be enabled for beam management, where the reporting configuration indicates for the UE to measure the requested quantity of CSI-RS ports for the beam management.

In some examples, the request message indicates a threshold quantity of CSI-RS ports supported by the UE for the beam management.

In some examples, to support receiving the one or more reports, the reporting component 1125 may be configured as or otherwise support a means for receiving a report including an indication of a throughput metric associated with each CSI-RS resource of the CSI-RS resource set, a reference signal received power associated with each CSI-RS resource of the CSI-RS resource set, a signal to interference and noise ratio associated with each CSI-RS resource of the CSI-RS resource set, or any combination thereof.

In some examples, to support receiving the one or more reports, the reporting component 1125 may be configured as or otherwise support a means for receiving a report including the CSI for a subset of CSI-RS resources, the report further including an indication of a reference signal received power associated with the subset of CSI-RS resources, a signal to interference and noise ratio associated with the subset of CSI-RS resources, or both.

In some examples, the configuration component 1130 may be configured as or otherwise support a means for transmitting a second control message indicating a configuration of one or more SRSs associated with throughput-based beam management, where the one or more SRSs are each associated with multiple antenna ports. In some examples, the reference signal component 1145 may be configured as or otherwise support a means for receiving the one or more SRSs based on the configuration.

In some examples, the reporting component 1125 may be configured as or otherwise support a means for transmitting one or more SSBs, where the beam management information is based on the one or more SSBs, and where the beam management information includes an indication of a throughput for each beam associated with a respective SSB.

In some examples, each SSB of the one or more SSBs is associated with two or more antenna ports.

In some examples, each beam is associated with a first SSB occasion corresponding to a first polarization and a second SSB occasion corresponding to a second polarization different from the first polarization.

In some examples, the capability message includes an indication of a quantity of beam reports supported by the UE, the one or more reports being based on the quantity of beam reports supported by the UE. In some examples, the quantity of beam reports is based on a threshold quantity of beam reports for beam management reporting, a threshold quantity of beam reports for CSI reporting, a threshold quantity of beam reports for throughput-based beam reporting, or any combination thereof.

In some examples, the configuration component 1130 may be configured as or otherwise support a means for transmitting an indication of one or more parameters associated with uplink interference, noise, or both, per beam of a set of beams supported by the UE, where a set of beams for communications with the UE are based on the one or more parameters.

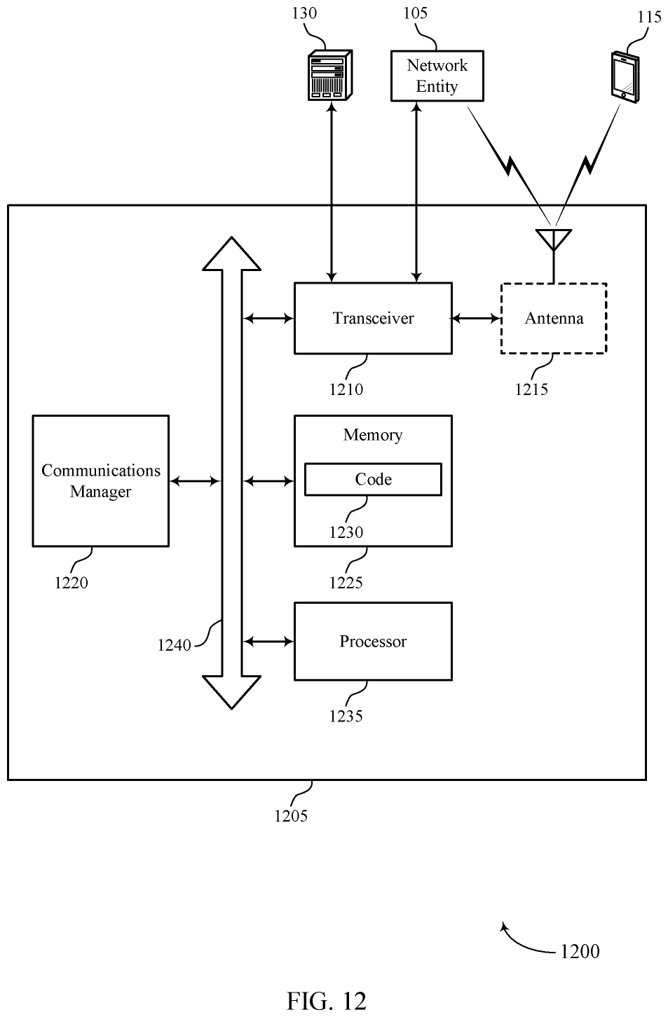

FIG. 12 shows a diagram of a system 1200 including a device 1205 that

supports throughput-based beam reporting techniques in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, the transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting throughput-based beam reporting techniques). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for receiving a capability message indicating a capability of a UE to support joint reporting of beam management information and CSI. The communications manager 1220 may be configured as or otherwise support a means for transmitting a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The communications manager 1220 may be configured as or otherwise support a means for receiving one or more reports including the beam management information and the CSI based on the reporting configuration.

By including or configuring the communications manager 1220 in accordance with examples as described herein, the device 1205 may support techniques for joint reporting of beam management information and CSI which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of throughput-based beam reporting techniques as described herein, or the processor 1235 and the memory 1225 may be otherwise configured to perform or support such operations.

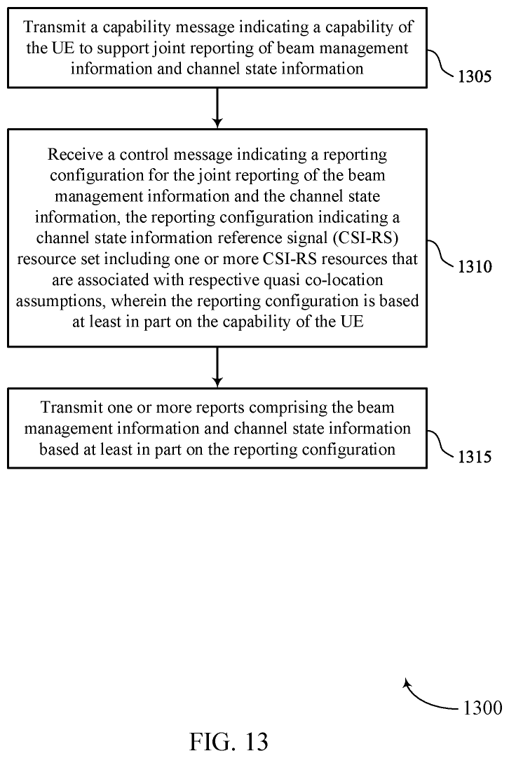

FIG. 13 shows a flowchart illustrating a method 1300 that supports throughput-based beam reporting techniques in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating a capability of the UE to support joint reporting of beam management information and CSI. The operations of 1305 may be performed in accordance with examples as disclosed herein. In some examples, aspects of the operations of 1305 may be performed by a capability component 725 as described with reference to FIG. 7. Additionally, or alternatively, means for performing 1305 may, but not necessarily, include, for example, antenna 825, transceiver 815, communications manager 820, memory 830 (including code 835), processor 840, and/or bus 845.

At 1310, the method may include receiving a control message indicating a reporting configuration for the joint reporting of the beam management information and the CSI, the reporting configuration indicating a CSI reference signal (CSI-RS) resource set including one or more CSI-RS resources that are associated with respective QCL assumptions, where the reporting configuration is based on the capability of the UE. The operations of 1310 may be performed in accordance with examples as disclosed herein. In some examples, aspects of the operations of 1310 may be performed by a configuration component 730 as described with reference to FIG. 7. Additionally, or alternatively, means for performing 1310 may, but not necessarily, include, for example, antenna 825, transceiver 815, communications manager 820, memory 830 (including code 835), processor 840, and/or bus 845.

At 1315, the method may include transmitting one or more reports including the beam management information and CSI based on the reporting configuration. The operations of 1315 may be performed in accordance with examples as disclosed herein. In some examples, aspects of the operations of 1315 may be performed by a reporting component 735 as described with reference to FIG. 7. Additionally, or alternatively, means for performing 1315 may, but not necessarily, include, for example, antenna 825, transceiver 815, communications manager 820, memory 830 (including code 835), processor 840, and/or bus 845.

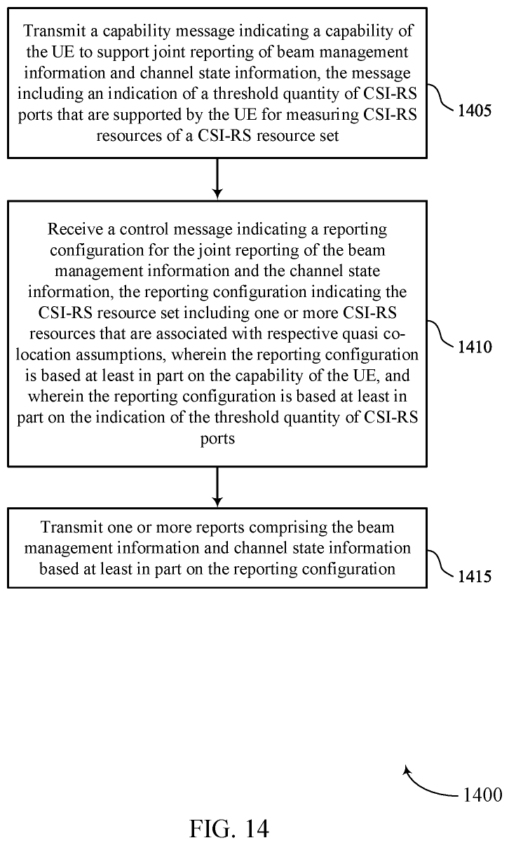

FIG. 14 shows a flowchart illustrating a method 1400 that supports throughput-based beam reporting techniques in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating a capability of a UE to support joint reporting of beam management information and channel state information, the message including an indication of a threshold quantity of CSI-RS ports that are supported by the UE for measuring CSI-RS resources of a CSI-RS resource set. The operations of 405 may be performed in accordance with examples as disclosed herein. In some examples, aspects of the operations of 1405 may be performed by a capability component 725 as described with reference to FIG. 7. Additionally, or alternatively, means for performing 1405 may, but not necessarily, include, for example, antenna 825, transceiver 815, communications manager 820, memory 830 (including code 835), processor 840, and/or bus 845.

At 1410, the method may include receiving a control message indicating a reporting configuration for the joint reporting of the beam management information and the channel state information, the reporting configuration indicating the CSI-RS resource set including one or more CSI-RS resources that are associated with respective quasi co-location assumptions, where the reporting configuration is based on the capability of the UE. In some aspects, the reporting configuration may be based on the indication of the threshold quantity of CSI-RS ports. The operations of 1410 may be performed in accordance with examples as disclosed herein. In some examples, aspects of the operations of 1410 may be performed by a configuration component 730 as described with reference to FIG. 7. Additionally, or alternatively, means for performing 1410 may, but not necessarily, include, for example, antenna 825, transceiver 815, communications manager 820, memory 830 (including code 835), processor 840, and/or bus 845.

At 1415, the method may include transmitting one or more reports including the beam management information and channel state information based on the reporting configuration. The operations of 1415 may be performed in accordance with examples as disclosed herein. In some examples, aspects of the operations of 1415 may be performed by a reporting component 735 as described with reference to FIG. 7. Additionally, or alternatively, means for performing 1415 may, but not necessarily, include, for example, antenna 825, transceiver 815, communications manager 820, memory 830 (including code 835), processor 840, and/or bus 845.

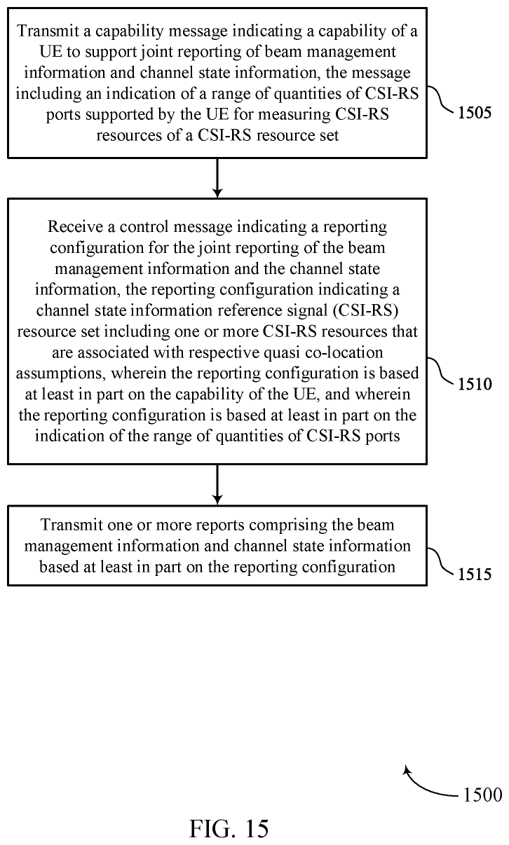

FIG. 15 shows a flowchart illustrating a method 1500 that supports throughput-based beam reporting techniques in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message indicating a capability of a UE to support joint reporting of beam management information and channel state information, the capability message including an indication of a range of quantities of CSI-RS ports supported by the UE for measuring CSI-RS resources of a CSI-RS resource set. The operations of 1505 may be performed in accordance with examples as disclosed herein. In some examples, aspects of the operations of 1505 may be performed by a capability component 725 as described with reference to FIG. 7. Additionally, or alternatively, means for performing 1505 may, but not necessarily, include, for example, antenna 825, transceiver 815, communications manager 820, memory 830 (including code 835), processor 840, and/or bus 845.

At 1510, the method may include receiving a control message indicating a reporting configuration for the joint reporting of the beam management information and the channel state information, the reporting configuration indicating the CSI-RS resource set including one or more CSI-RS resources that are associated with respective quasi co-location assumptions, where the reporting configuration is based on the capability of the UE. In some aspects, the reporting configuration may be based on the indication of the range of quantities of CSI-RS ports. The operations of 1510 may be performed in accordance with examples as disclosed herein. In some examples, aspects of the operations of 1510 may be performed by a configuration component 730 as described with reference to FIG. 7. Additionally, or alternatively, means for performing 1510 may, but not necessarily, include, for example, antenna 825, transceiver 815, communications manager 820, memory 830 (including code 835), processor 840, and/or bus 845.

At 1515, the method may include transmitting one or more reports including the beam management information and channel state information based on the reporting configuration. The operations of 1515 may be performed in accordance with examples as disclosed herein. In some examples, aspects of the operations of 1515 may be performed by a reporting component 735 as described with reference to FIG. 7. Additionally, or alternatively, means for performing 1515 may, but not necessarily, include, for example, antenna 825, transceiver 815, communications manager 820, memory 830 (including code 835), processor 840, and/or bus 845.

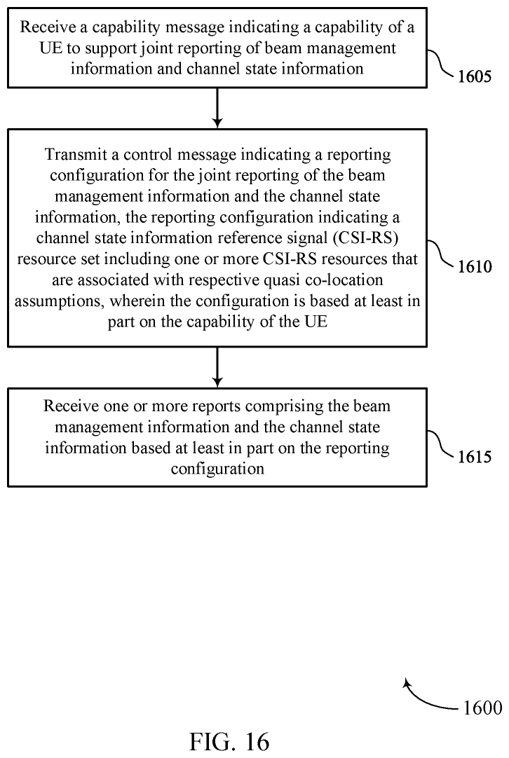

FIG. 16 shows a flowchart illustrating a method 1600 that supports throughput-based beam reporting techniques in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability message indicating a capability of a UE to support joint reporting of beam management information and channel state information. The operations of 1605 may be performed in accordance with examples as disclosed herein. In some examples, aspects of the operations of 1605 may be performed by a reporting component 1125 as described with reference to FIG. 11. Additionally, or alternatively, means for performing 1605 may, but not necessarily, include, for example, antenna 1215, transceiver 1210, communications manager 1220, a memory 1225 (including code 1230), processor 1235, and/or bus 1240.

At 1610, the method may include transmitting a control message indicating a reporting configuration for the joint reporting of the beam management information and the channel state information, the reporting configuration indicating a CSI-RS resource set including one or more CSI-RS resources that are associated with respective quasi co-location assumptions, where the configuration is based on the capability of the UE. The operations of 1610 may be performed in accordance with examples as disclosed herein. In some examples, aspects of the operations of 1610 may be performed by a configuration component 1130 as described with reference to FIG. 11. Additionally, or alternatively, means for performing 1610 may, but not necessarily, include, for example, antenna 1215, transceiver 1210, communications manager 1220, a memory 1225 (including code 1230), processor 1235, and/or bus 1240.

At 1615, the method may include receiving one or more reports including the beam management information and the channel state information based on the reporting configuration. The operations of 1615 may be performed in accordance with examples as disclosed herein. In some examples, aspects of the operations of 1615 may be performed by a capability component 1135 as described with reference to FIG. 11. Additionally, or alternatively, means for performing 1615 may, but not necessarily, include, for example, antenna 1215, transceiver 1210, communications manager 1220, a memory 1225 (including code 1230), processor 1235, and/or bus 1240.

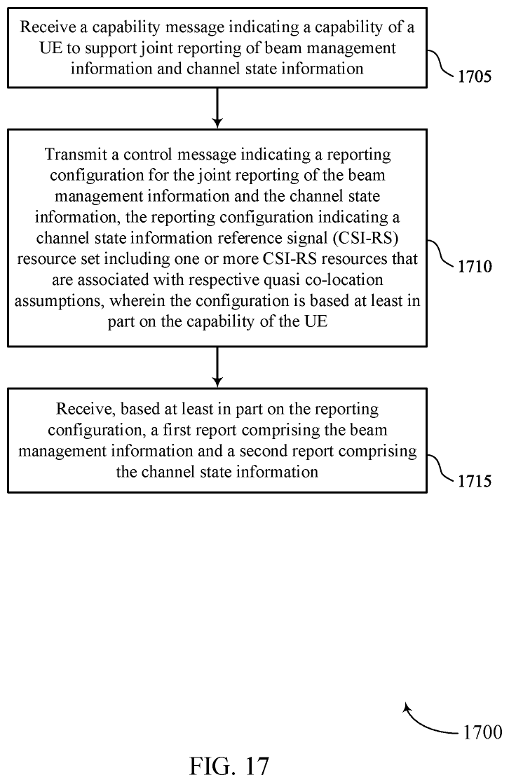

FIG. 17 shows a flowchart illustrating a method 1700 that supports throughput-based beam reporting techniques in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include receiving a capability message indicating a capability of a UE to support joint reporting of beam management information and channel state information. The operations of 1705 may be performed in accordance with examples as disclosed herein. In some examples, aspects of the operations of 1705 may be performed by a reporting component 1125 as described with reference to FIG. 11. Additionally, or alternatively, means for performing 1705 may, but not necessarily, include, for example, antenna 1215, transceiver 1210, communications manager 1220, a memory 1225 (including code 1230), processor 1235, and/or bus 1240.

At 1710, the method may include transmitting a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, where the configuration is based on the capability of the UE. The operations of 1710 may be performed in accordance with examples as disclosed herein. In some examples, aspects of the operations of 1710 may be performed by a configuration component 1130 as described with reference to FIG. 11. Additionally, or alternatively, means for performing 1710 may, but not necessarily, include, for example, antenna 1215, transceiver 1210, communications manager 1220, a memory 1225 (including code 1230), processor 1235, and/or bus 1240.

At 1715, the method may include receiving, based on the reporting configuration, a first report including the beam management information and a second report including the channel state information. The operations of 1715 may be performed in accordance with examples as disclosed herein. In some examples, aspects of the operations of 1715 may be performed by a capability component 1135 as described with reference to FIG. 11. Additionally, or alternatively, means for performing 1715 may, but not necessarily, include, for example, antenna 1215, transceiver 1210, communications manager 1220, a memory 1225 (including code 1230), processor 1235, and/or bus 1240.

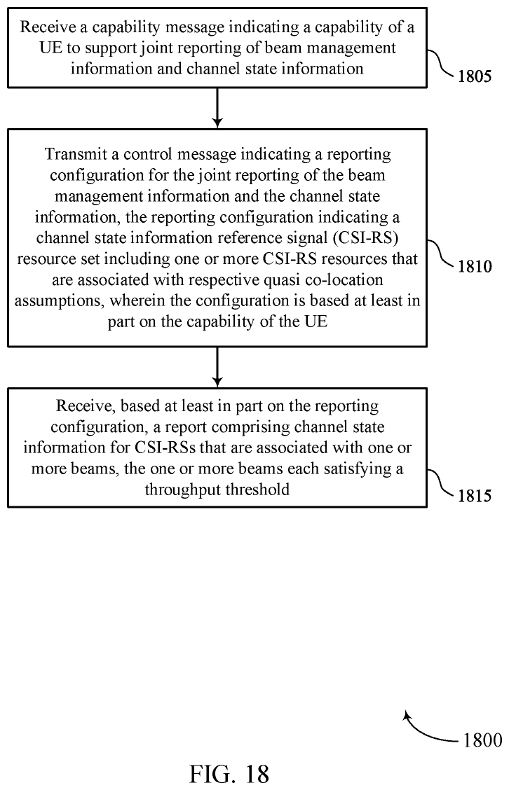

FIG. 18 shows a flowchart illustrating a method 1800 that supports throughput-based beam reporting techniques in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include receiving a capability message indicating a capability of a UE to support joint reporting of beam management information and channel state information. The operations of 1805 may be performed in accordance with examples as disclosed herein. In some examples, aspects of the operations of 1805 may be performed by a reporting component 1125 as described with reference to FIG. 11. Additionally, or alternatively, means for performing 1805 may, but not necessarily, include, for example, antenna 1215, transceiver 1210, communications manager 1220, a memory 1225 (including code 1230), processor 1235, and/or bus 1240.

At 1810, the method may include transmitting a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, where the configuration is based on the capability of the UE. The operations of 1810 may be performed in accordance with examples as disclosed herein. In some examples, aspects of the operations of 1810 may be performed by a configuration component 1130 as described with reference to FIG. 11. Additionally, or alternatively, means for performing 1810 may, but not necessarily, include, for example, antenna 1215, transceiver 1210, communications manager 1220, a memory 1225 (including code 1230), processor 1235, and/or bus 1240.

At 1815, the method may include receiving, based on the reporting configuration, a report including channel state information for CSI-RSs that are associated with one or more beams, the one or more beams each satisfying a throughput threshold. The operations of 1815 may be performed in accordance with examples as disclosed herein. In some examples, aspects of the operations of 1815 may be performed by a capability component 1135 as described with reference to FIG. 11. Additionally, or alternatively, means for performing 1815 may, but not necessarily, include, for example, antenna 1215, transceiver 1210, communications manager 1220, a memory 1225 (including code 1230), processor 1235, and/or bus 1240.

The following provides an overview of aspects of the present disclosure:

Aspect 1: A method for wireless communications at a UE, comprising: transmitting a capability message indicating a capability of the UE to support joint reporting of beam management information and CSI; receiving a control message indicating a reporting configuration for the joint reporting of the beam management information and the CSI, the reporting configuration indicating a CSI-RS resource set including one or more CSI-RS resources that are associated with respective QCL assumptions, wherein the reporting configuration is based at least in part on the capability of the UE; and transmitting one or more reports comprising the beam management information and the CSI based at least in part on the reporting configuration.

Aspect 2: The method of aspect 1, wherein transmitting the capability message comprises: transmitting the capability message including an indication of a threshold quantity of CSI-RS ports that are supported by the UE for measuring CSI-RS resources of the CSI-RS resource set, wherein the reporting configuration is based at least in part on the indication of the threshold quantity of CSI-RS ports.

Aspect 3: The method of aspect 2, wherein the threshold quantity of CSI-RS ports comprises a quantity of CSI-RS ports that are supported by the UE for a plurality of reporting configurations for the joint reporting of the beam management information and the CSI, the threshold quantity of CSI-RS ports being indicated per BWP, per CC, for a plurality of CCs, or any combination thereof.

Aspect 4: The method of aspect 1, wherein transmitting the capability message comprises: transmitting the capability message including an indication of a range of quantities of CSI-RS ports supported by the UE for measuring CSI-RS resources of the CSI-RS resource set, wherein the reporting configuration is based at least in part on the indication of the range of quantities of CSI-RS ports.

Aspect 5: The method of aspect 4, wherein the range of quantities of CSI-RS ports comprises a range of quantities of CSI-RS ports that are supported by the UE for plurality of reporting configurations for the joint reporting of the beam management information and the CSI, the range of quantities of CSI-RS ports being indicated per BWP, per CC, for a plurality of CCs, or any combination thereof.

Aspect 6: The method of any of aspects 1 through 5, further comprising: performing measurements of respective CSI-RS resources of the CSI-RS resource set for acquiring the beam management information, wherein the respective CSI-RS resources are each associated with a plurality of antenna ports, the respective CSI-RS resources being configured without repetition and are each associated with different antenna ports.

Aspect 7: The method of any of aspects 1 through 5, further comprising: performing measurements of respective CSI-RS resources of the CSI-RS resource set for acquiring the CSI, wherein the respective CSI-RS resources are each associated with a plurality of antenna ports, the respective CSI-RS resources being configured with repetition.

Aspect 8: The method of any of aspects 1 through 5, further comprising: performing measurements of respective CSI-RS resources of the CSI-RS resource set for acquiring the beam management information and the CSI, wherein the respective CSI-RS resources are each associated with a plurality of antenna ports.

Aspect 9: The method of any of aspects 1 through 8, further comprising: performing measurements of the one or more CSI-RS resources of the CSI-RS resource set for acquiring the beam management information and the CSI, wherein transmitting the one or more reports comprises: transmitting, based at least in part on the measurements, a first report comprising the beam management information and a second report comprising the CSI.

Aspect 10: The method of any of aspects 1 through 8, further comprising: performing measurements of the one or more CSI-RS resources of the CSI-RS resource set for acquiring the beam management information and the CSI, wherein transmitting the one or more reports comprises: transmitting a report comprising CSI for CSI-RSs that are associated with one or more beams, the one or more beams each satisfying a throughput threshold based at least in part on the measurements.

Aspect 11: The method of any of aspects 1 through 8, further comprising: performing measurements of the one or more CSI-RS resources of the CSI-RS resource set for acquiring the beam management information and the CSI, wherein transmitting the one or more reports comprises: transmitting a report comprising a first report quantity associated with the beam management information and a second report quantity associated with the CSI.

Aspect 12: The method of aspect 11, wherein the first report quantity comprises a first CSI-RS resource identifier value and a reference signal received power value, and the second report quantity comprises a second CSI-RS resource identifier value, a RI value, a PMI value, a CQI value, or any combination thereof.

Aspect 13: The method of any of aspects 1 through 8, further comprising: performing measurements of the one or more CSI-RS resources of the CSI-RS resource set for acquiring the beam management information and the CSI, wherein transmitting the one or more reports comprises: transmitting a report comprising a joint report quantity associated with the beam management information and the CSI.

Aspect 14: The method of aspect 13, wherein the joint report quantity comprises a CSI-RS resource identifier value, a reference signal received power value, a RI value, a PMI value, a CQI value, or any combination thereof.

Aspect 15: The method of any of aspects 1 through 14, further comprising: transmitting a request message requesting a quantity of CSI-RS ports associated with the one or more CSI-RS resources of the CSI-RS resource set to be enabled for beam management, wherein the reporting configuration indicates for the UE to measure the quantity of CSI-RS ports for the beam management.

Aspect 16: The method of aspect 15, wherein the request message comprises an indication of a threshold quantity of CSI-RS ports supported by the UE for the beam management.

Aspect 17: The method of any of aspects 1 through 16, wherein transmitting the one or more reports comprises: transmitting a report comprising an indication of a throughput metric associated with each CSI-RS resource of the CSI-RS resource set, a reference signal received power associated with each CSI-RS resource of the CSI-RS resource set, a signal to interference and noise ratio associated with each CSI-RS resource of the CSI-RS resource set, or any combination thereof.

Aspect 18: The method of any of aspects 1 through 17, further comprising: performing measurements of the one or more CSI-RS resources of the CSI-RS resource set to acquire the CSI; and selecting a subset of CSI-RS resources from the CSI-RS resource set based at least in part on one or more throughput metrics associated with the subset of CSI-RS resources, the one or more throughput metrics being based at least in part on the measurements, wherein transmitting the one or more reports comprises: transmitting a report comprising the CSI for the subset of CSI-RS resources, the report further comprising an indication of a reference signal received power associated with the subset of CSI-RS resources, a signal to interference and noise ratio associated with the subset of CSI-RS resources, or both.

Aspect 19: The method of any of aspects 1 through 17, further comprising: receiving a second control message indicating a configuration of one or more SRSs associated with throughput-based beam management, wherein the one or more SRSs are each associated with multiple antenna ports; and transmitting the one or more SRSs based at least in part on the configuration.

Aspect 20: The method of any of aspects 1 through 19, further comprising: receiving one or more SSBs; and performing measurements of the one or more SSBs, wherein the beam management information is based at least in part on the measurements, and wherein the beam management information includes an indication of a throughput for each beam associated with a respective SSB.

Aspect 21: The method of aspect 20, wherein each SSB of the one or more SSBs is associated with two or more antenna ports.

Aspect 22: The method of any of aspects 20 through 21, wherein each beam is associated with a first SSB occasion corresponding to a first polarization and a second SSB occasion corresponding to a second polarization different from the first polarization.

Aspect 23: The method of any of aspects 1 through 22, further comprising: calculating a total quantity of CSI processing units based at least in part on a first quantity of CSI processing units associated with reporting the beam management information, a second quantity of CSI processing units associated with reporting the CSI, or both; and generating the beam management information, the CSI, or both, based at least in part on the total quantity of CSI processing units.

Aspect 24: The method of any of aspects 1 through 23, further comprising: calculating a total quantity of symbols associated with CSI processing unit occupation based at least in part on a first quantity of symbols associated with reporting the beam management information, a second quantity of symbols associated with reporting the CSI, or both; and generating the beam management information, the CSI, or both, based at least in part on the total quantity of symbols.

Aspect 25: The method of any of aspects 1 through 24, further comprising: calculating a quantity of beam reports supported by the UE for reporting the beam management information, the quantity of beam reports being based at least in part on a threshold quantity of beam reports for beam management reporting, a threshold quantity of beam reports for CSI reporting, a threshold quantity of beam reports for throughput-based beam reporting, or any combination thereof, wherein transmitting the capability message comprises: transmitting the capability message including an indication of the quantity of beam reports, the one or more reports being based at least in part on the quantity of beam reports supported by the UE.

Aspect 26: The method of any of aspects 1 through 25, further comprising: receiving an indication of one or more parameters associated with uplink interference, noise, or both, per beam of a set of beams supported by the UE; and selecting one or more beams for communications based at least in part on the indication of the one or more parameters.

Aspect 27: A method for wireless communications at a network entity, comprising: receiving a capability message indicating a capability of a UE to support joint reporting of beam management information and channel state information; transmitting a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, wherein the configuration is based at least in part on the capability of the UE; and receiving one or more reports comprising the beam management information and the channel state information based at least in part on the reporting configuration.

Aspect 28: The method of aspect 27, wherein receiving the capability message comprises: receiving the capability message including an indication of a threshold quantity of CSI-RS ports that are supported by the UE for measuring CSI-RS resources of the CSI-RS resource set, wherein the reporting configuration is based at least in part on the indication of the threshold quantity of CSI-RS ports.

Aspect 29: The method of aspect 28, wherein the threshold quantity of CSI-RS ports comprises a quantity of CSI-RS ports that are supported by the UE for a plurality of reporting configurations for the joint reporting of the beam management information and the channel state information, the threshold quantity of CSI-RS ports being indicated per bandwidth part, per component carrier, for a plurality of component carriers, or any combination thereof.

Aspect 30: The method of aspect 27, wherein receiving the capability message comprises: receiving the capability message including an indication of a range of quantities of CSI-RS ports supported by the UE for measuring CSI-RS resources of the CSI-RS resource set, wherein the reporting configuration is based at least in part on the indication of the range of quantities of CSI-RS ports.

Aspect 31: The method of aspect 30, wherein the range of quantities of CSI-RS ports comprises a range of quantities of CSI-RS ports that are supported by the UE for plurality of reporting configurations for the joint reporting of the beam management information and the channel state information, the range of quantities of CSI-RS ports being indicated per bandwidth part, per component carrier, for a plurality of component carriers, or any combination thereof.

Aspect 32: The method of any of aspects 27 through 31, wherein receiving the one or more reports comprises: receiving a first report comprising the beam management information and a second report comprising the channel state information.

Aspect 33: The method of any of aspects 27 through 31, wherein receiving the one or more reports comprises: receiving a report comprising channel state information for CSI-RSs that are associated with one or more beams, the one or more beams each satisfying a throughput threshold.

Aspect 34: The method of any of aspects 27 through 31, wherein receiving the one or more reports comprises: receiving a report comprising a first report quantity associated with the beam management information and a second report quantity associated with the channel state information.

Aspect 35: The method of aspect 34, wherein the first report quantity comprises a first CSI-RS resource identifier value and a reference signal received power value, and the second report quantity comprises a second CSI-RS resource identifier value, a rank indicator value, a precoding matrix indicator value, a channel quality indicator value, or any combination thereof.

Aspect 36: The method of any of aspects 27 through 31, wherein receiving the one or more reports comprises: receiving a report comprising a joint report quantity associated with the beam management information and the channel state information.

Aspect 37: The method of aspect 36, wherein the joint report quantity comprises a CSI-RS resource identifier value, a reference signal received power value, a rank indicator value, a precoding matrix indicator value, a channel quality indicator value, or any combination thereof.

Aspect 38: The method of any of aspects 27 through 37, further comprising: receiving a request message requesting a quantity of CSI-RS ports associated with the one or more CSI-RS resources of the CSI-RS resource set to be enabled for beam management, wherein the reporting configuration indicates for the UE to measure the requested quantity of CSI-RS ports for the beam management.

Aspect 39: The method of aspect 38, wherein the request message indicates a threshold quantity of CSI-RS ports supported by the UE for the beam management.

Aspect 40: The method of any of aspects 27 through 39, wherein receiving the one or more reports comprises: receiving a report comprising an indication of a throughput metric associated with each CSI-RS resource of the CSI-RS resource set, a reference signal received power associated with each CSI-RS resource of the CSI-RS resource set, a signal to interference and noise ratio associated with each CSI-RS resource of the CSI-RS resource set, or any combination thereof.

Aspect 41: The method of any of aspects 27 through 40, wherein receiving the one or more reports comprises: receiving a report comprising the channel state information for a subset of CSI-RS resources, the report further comprising an indication of a reference signal received power associated with the subset of CSI-RS resources, a signal to interference and noise ratio associated with the subset of CSI-RS resources, or both.

Aspect 42: The method of any of aspects 27 through 41, further comprising: transmitting a second control message indicating a configuration of one or more sounding reference signals associated with throughput-based beam management, wherein the one or more sounding reference signals are each associated with multiple antenna ports; and receiving the one or more sounding reference signals based at least in part on the configuration.

Aspect 43: The method of any of aspects 27 through 42, further comprising: transmitting one or more synchronization signal blocks, wherein the beam management information is based at least in part on the one or more synchronization signal blocks, and wherein the beam management information includes an indication of a throughput for each beam associated with a respective synchronization signal block.

Aspect 44: The method of aspect 43, wherein each synchronization signal block of the one or more synchronization signal blocks is associated with two or more antenna ports.

Aspect 45: The method of any of aspects 43 through 44, wherein each beam is associated with a first synchronization signal block occasion corresponding to a first polarization and a second synchronization signal block occasion corresponding to a second polarization different from the first polarization.

Aspect 46: The method of any of aspects 27 through 45, wherein the second message includes an indication of a quantity of beam reports supported by the UE, the one or more reports being based at least in part on the quantity of beam reports supported by the UE, and the quantity of beam reports is based at least in part on a threshold quantity of beam reports for beam management reporting, a threshold quantity of beam reports for channel state information reporting, a threshold quantity of beam reports for throughput-based beam reporting, or any combination thereof.

Aspect 47: The method of any of aspects 27 through 46, further comprising: transmitting an indication of one or more parameters associated with uplink interference, noise, or both, per beam of a set of beams supported by the UE, wherein a set of beams for communications with the UE are based at least in part on the one or more parameters.

Aspect 48: An apparatus for wireless communications at a UE, comprising a processor; memory coupled with the processor; and instructions stored in the memory and executable by the processor to cause the apparatus to perform a method of any of aspects 1 through 26.

Aspect 49: An apparatus for wireless communications at a UE, comprising at least one means for performing a method of any of aspects 1 through 26.

Aspect 50: A non-transitory computer-readable medium storing code for wireless communications at a UE, the code comprising instructions executable by a processor to perform a method of any of aspects 1 through 26.

Aspect 51: An apparatus for wireless communications at a network entity, comprising a processor; memory coupled with the processor; and instructions stored in the memory and executable by the processor to cause the apparatus to perform a method of any of aspects 27 through 47.

Aspect 52: An apparatus for wireless communications at a network entity, comprising at least one means for performing a method of any of aspects 27 through 47.

Aspect 53: A non-transitory computer-readable medium storing code for wireless communications at a network entity, the code comprising instructions executable by a processor to perform a method of any of aspects 27 through 47.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting a capability message indicating a capability of the UE to support joint reporting of beam management information and channel state information;
receiving a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, wherein the reporting configuration is based at least in part on the capability of the UE; and
transmitting one or more reports comprising the beam management information and the channel state information based at least in part on the reporting configuration.

2. The method of claim 1, wherein transmitting the capability message comprises:
transmitting the capability message including an indication of a threshold quantity of CSI-RS ports that are supported by the UE for measuring CSI-RS resources of the CSI-RS resource set, wherein the reporting configuration is based at least in part on the indication of the threshold quantity of CSI-RS ports.

3. The method of claim 2, wherein the threshold quantity of CSI-RS ports comprises a quantity of CSI-RS ports that are supported by the UE for a plurality of reporting configurations for the joint reporting of the beam management information and the channel state information, the threshold quantity of CSI-RS ports being indicated per bandwidth part, per component carrier, for a plurality of component carriers, or any combination thereof.

4. The method of claim 1, wherein transmitting the capability message comprises:
transmitting the capability message including an indication of a range of quantities of CSI-RS ports supported by the UE for measuring CSI-RS resources of the CSI-RS resource set, wherein the reporting configuration is based at least in part on the indication of the range of quantities of CSI-RS ports.

5. The method of claim 4, wherein the range of quantities of CSI-RS ports comprises a range of quantities of CSI-RS ports that are supported by the UE for plurality of reporting configurations for the joint reporting of the beam management information and the channel state information, the range of quantities of CSI-RS ports being indicated per bandwidth part, per component carrier, for a plurality of component carriers, or any combination thereof.

6. The method of claim 1, further comprising:
performing measurements of respective CSI-RS resources of the CSI-RS resource set for acquiring the beam management information, wherein the respective CSI-RS resources are each associated with a plurality of antenna ports, the respective CSI-RS resources being configured without repetition and are each associated with different antenna ports.

7. The method of claim 1, further comprising:
performing measurements of respective CSI-RS resources of the CSI-RS resource set for acquiring the channel state information, wherein the respective CSI-RS resources are each associated with a plurality of antenna ports, the respective CSI-RS resources being configured with repetition.

8. The method of claim 1, further comprising:
performing measurements of respective CSI-RS resources of the CSI-RS resource set for acquiring the beam management information and the channel state information, wherein the respective CSI-RS resources are each associated with a plurality of antenna ports.

9. The method of claim 1, further comprising:
performing measurements of the one or more CSI-RS resources of the CSI-RS resource set for acquiring the beam management information and the channel state information, wherein transmitting the one or more reports comprises:
transmitting, based at least in part on the measurements, a first report comprising the beam management information and a second report comprising the channel state information.

10. The method of claim 1, further comprising:
performing measurements of the one or more CSI-RS resources of the CSI-RS resource set for acquiring the beam management information and the channel state information, wherein transmitting the one or more reports comprises:
transmitting a report comprising channel state information for CSI-RSs that are associated with one or more beams, the one or more beams each satisfying a throughput threshold based at least in part on the measurements.

11. The method of claim 1, further comprising:
performing measurements of the one or more CSI-RS resources of the CSI-RS resource set for acquiring the beam management information and the channel state information, wherein transmitting the one or more reports comprises:
transmitting a report comprising a first report quantity associated with the beam management information and a second report quantity associated with the channel state information.

12. The method of claim 11, wherein the first report quantity comprises a first CSI-RS resource identifier value and a reference signal received power value, and wherein the second report quantity comprises a second CSI-RS resource identifier value, a rank indicator value, a precoding matrix indicator value, a channel quality indicator value, or any combination thereof.

13. The method of claim 1, further comprising:
performing measurements of the one or more CSI-RS resources of the CSI-RS resource set for acquiring the beam management information and the channel state information, wherein transmitting the one or more reports comprises:
transmitting a report comprising a joint report quantity associated with the beam management information and the channel state information.

14. The method of claim 13, wherein the joint report quantity comprises a CSI-RS resource identifier value, a reference signal received power value, a rank indicator value, a precoding matrix indicator value, a channel quality indicator value, or any combination thereof.

15. The method of claim 1, further comprising:
transmitting a request message requesting a quantity of CSI-RS ports associated with the one or more CSI-RS resources of the CSI-RS resource set to be enabled for beam management, wherein the reporting configuration indicates for the UE to measure the quantity of CSI-RS ports for the beam management.

16. The method of claim 15, wherein the request message comprises an indication of a threshold quantity of CSI-RS ports supported by the UE for the beam management.

17. The method of claim 1, wherein transmitting the one or more reports comprises:
transmitting a report comprising an indication of a throughput metric associated with each CSI-RS resource of the CSI-RS resource set, a reference signal received power associated with each CSI-RS resource of the CSI-RS resource set, a signal to interference and noise ratio associated with each CSI-RS resource of the CSI-RS resource set, or any combination thereof.

18. The method of claim 1, further comprising:
performing measurements of the one or more CSI-RS resources of the CSI-RS resource set to acquire the channel state information: and
selecting a subset of CSI-RS resources from the CSI-RS resource set based at least in part on one or more throughput metrics associated with the subset of CSI-RS resources, the one or more throughput metrics being based at least in part on the measurements, wherein transmitting the one or more reports comprises:
transmitting a report comprising the channel state information for the subset of CSI-RS resources, the report further comprising an indication of a reference signal received power associated with the subset of CSI-RS resources, a signal to interference and noise ratio associated with the subset of CSI-RS resources, or both.

19. The method of claim 1, further comprising:
receiving a second control message indicating a configuration of one or more sounding reference signals associated with throughput-based beam management, wherein the one or more sounding reference signals are each associated with multiple antenna ports: and
transmitting the one or more sounding reference signals based at least in part on the configuration.

20. The method of claim 1, further comprising:
receiving one or more synchronization signal blocks; and
performing measurements of the one or more synchronization signal blocks, wherein the beam management information is based at least in part on the measurements, and wherein the beam management information includes an indication of a throughput for each beam associated with a respective synchronization signal block.

21. The method of claim 20, wherein each synchronization signal block of the one or more synchronization signal blocks is associated with two or more antenna ports.

22. The method of claim 20, wherein each beam is associated with a first synchronization signal block occasion corresponding to a first polarization and a second synchronization signal block occasion corresponding to a second polarization different from the first polarization.

23. The method of claim 1, further comprising:
calculating a total quantity of channel state information processing units based at least in part on a first quantity of channel state information processing units associated with reporting the beam management information, a second quantity of channel state information processing units associated with reporting the channel state information, or both; and
generating the beam management information, the channel state information, or both, based at least in part on the total quantity of channel state information processing units.

24. The method of claim 1, further comprising:
calculating a total quantity of symbols associated with channel state information processing unit occupation based at least in part on a first quantity of symbols associated with reporting the beam management information, a second quantity of symbols associated with reporting the channel state information, or both; and
generating the beam management information, the channel state information, or both, based at least in part on the total quantity of symbols.

25. The method of claim 1, further comprising:
calculating a quantity of beam reports supported by the UE for reporting the beam management information, the quantity of beam reports being based at least in part on a threshold quantity of beam reports for beam management reporting, a threshold quantity of beam reports for channel state information reporting, a threshold quantity of beam reports for throughput-based beam reporting, or any combination thereof, wherein transmitting the capability message comprises:
transmitting the capability message including an indication of the quantity of beam reports, the one or more reports being based at least in part on the quantity of beam reports supported by the UE.

26. The method of claim 1, further comprising:
receiving an indication of one or more parameters associated with uplink interference, noise, or both, per beam of a set of beams supported by the UE: and
selecting one or more beams for communications based at least in part on the indication of the one or more parameters.

27. A method for wireless communications at a network entity, comprising:
receiving a capability message indicating a capability of a user equipment (UE) to support joint reporting of beam management information and channel state information;
transmitting a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, wherein the reporting configuration is based at least in part on the capability of the UE: and
receiving one or more reports comprising the beam management information and the channel state information based at least in part on the reporting configuration.

28. The method of claim 27, wherein receiving the capability message comprises:
receiving the capability message including an indication of a threshold quantity of CSI-RS ports that are supported by the UE for measuring CSI-RS resources of the CSI-RS resource set, wherein the reporting configuration is based at least in part on the indication of the threshold quantity of CSI-RS ports.

29. An apparatus for wireless communications at a user equipment (UE), comprising:
memory:
a transceiver; and
at least one processor of the UE, the at least one processor coupled with the memory and the transceiver, and the at least one processor configured to:
transmit, via the transceiver, a capability message indicating a capability of the UE to support joint reporting of beam management information and channel state information;
receive, via the transceiver, a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, wherein the reporting configuration is based at least in part on the capability of the UE; and
transmit, via the transceiver, one or more reports comprising the beam management information and the channel state information based at least in part on the reporting configuration.

30. An apparatus for wireless communications at a network entity, comprising:
memory;
a transceiver; and
at least one processor of the network entity, the at least one processor coupled with the memory and the transceiver, and the at least one processor configured to:
receive, via the transceiver, a capability message indicating a capability of a user equipment (UE) to support joint reporting of beam management information and channel state information;
transmit, via the transceiver, a control message indicating a reporting configuration for the joint reporting of the beam management information and the channel state information, the reporting configuration indicating a channel state information reference signal (CSI-RS) resource set including one or more CSI-RS resources that are associated with respective quasi co-location assumptions, wherein the reporting configuration is based at least in part on the capability of the UE; and
receive, via the transceiver, one or more reports comprising the beam management information and the channel state information based at least in part on the reporting configuration.
